(19) United States
(12) Patent Application Publication
(10) Pub. No.: US 2025/0159710 A1
(43) Pub. Date: May 15, 2025

(54) SIDELINK RESOURCE RESERVATION IN A SHARED BAND

(71) Applicant: QUALCOMM Incorporated, San Diego, CA (US)

(72) Inventors: Yisheng XUE, San Diego, CA (US); Xiaoxia ZHANG, San Diego, CA (US); Chih-Hao LIU, San Diego, CA (US); Jing SUN, San Diego, CA (US); Siyi CHEN, Beijing (CN); Giovanni CHISCI, San Diego, CA (US); Arumugam CHENDAMARAI KANNAN, San Diego, CA (US)

(21) Appl. No.: 18/839,919

(22) PCT Filed: Apr. 29, 2022
(86) PCT No.: PCT/CN2022/090195

§ 371 Date: Aug. 20, 2024

(51) Int. Cl. H04W 72/50; H04W 72/40; H04W 72/542; H04W 74/0808

(52) U.S. Cl. CPC H04W 72/535; H04W 72/40; H04W 72/542; H04W 74/0808

(57) ABSTRACT

Methods, systems, and devices for wireless communication are described to support determining, at one or more sidelink user equipments (UEs), a competition level associated with another radio access technology (RAT) sharing a frequency band with the one or more sidelink UEs. A UE may determine a competition level from another RAT and may reserve resources in a sidelink resource pool based on the based on the determined competition level. For example, the UE may determine a signal strength associated with the other RAT, or may determine a ratio of failed LBT procedures, or both, based on monitoring one or more resources of the sidelink resource pool. Based on the determined competition level, the UE may determine a number of resources to reserve, or a reservation reliability, or both. The UE may transmit a resource reservation indicating the number of reserved resources, the reservation reliability, or both.

### CROSS REFERENCE

The present Application is a 371 national phase filing of International PCT Application No. PCT/CN2022/090195 by XUE et al., entitled “SIDELINK RESOURCE RESERVATION IN A SHARED BAND,” filed Apr. 29, 2022, which is assigned to the assignee hereof, and which is expressly incorporated by reference in its entirety herein.

### FIELD OF TECHNOLOGY

The following relates to wireless communication, including sidelink resource reservation in a shared band.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some UEs may communicate directly with each other, for example, via one or more sidelink channels, and may reserve resources for sidelink communications, such as time resources, frequency resources, or any combination thereof.

### SUMMARY

The described techniques relate to improved methods, systems, devices, and apparatuses that support sidelink resource reservation in a shared band. For example, the described techniques support determining, at one or more sidelink user equipments (UEs), a competition level associated with one or more radio access technologies (RATs) sharing a frequency band with the one or more sidelink UEs. A UE may, for example, operate in an unlicensed sidelink band (e.g., sidelink unlicensed (SL-U) band), and may determine a competition level from the one or more RATs. The UE may reserve resources in a sidelink resource pool based on the determined competition level. For example, the UE may, in some cases, reserve a first number of resources per SCI, but to make the resource reservation more reliable, the UE may reserve fewer than the first number of resources if the UE detects competition from the one or more RATs. As such, the UE may determine a number of reservations the UE is permitted to make per sidelink control information (SCI) based on observed competition from the one or more RATs.

To support determination of a competition level from the one or more RATs, the UE may determine a signal strength associated with the other RAT(s), or may determine a ratio of failed LBT procedures, or both, based on monitoring one or more resources of the sidelink resource pool. Based on the determined competition level, the UE may determine a number of resources to reserve using SCI, or may determine a reservation reliability (e.g., among other examples), or both. The UE may transmit a resource reservation (e.g., via SCI) indicating the number of reserved resources, the reservation reliability, or both, based on the determined competition level (e.g., a competition level metric).

A method for wireless communication of a UE operating using a first RAT is described. The method may include identifying a sidelink resource pool of a shared resource band and a parameter of a competition level metric for measuring communication activity in the shared resource band, the shared resource band associated with communication by the first RAT and a second RAT that differs from the first RAT, monitoring, in accordance with the parameter of the competition level metric, at least one resource of the sidelink resource pool to determine the competition level metric for the shared resource band, and transmitting one or more reservations for reserving one or more resources of the sidelink resource pool based at least on part on the competition level metric.

An apparatus for wireless communication of a UE operating using a first RAT is described. The apparatus may include a processor, memory coupled with the processor, and instructions stored in the memory. The instructions may be executable by the processor to cause the apparatus to identify a sidelink resource pool of a shared resource band and a parameter of a competition level metric for measuring communication activity in the shared resource band, the shared resource band associated with communication by the first RAT and a second RAT that differs from the first RAT, monitor, in accordance with the parameter of the competition level metric, at least one resource of the sidelink resource pool to determine the competition level metric for the shared resource band, and transmit one or more reservations for reserving one or more resources of the sidelink resource pool based at least on part on the competition level metric.

Another apparatus for wireless communication of a UE operating using a first RAT is described. The apparatus may include means for identifying a sidelink resource pool of a shared resource band and a parameter of a competition level metric for measuring communication activity in the shared resource band, the shared resource band associated with communication by the first RAT and a second RAT that differs from the first RAT, means for monitoring, in accordance with the parameter of the competition level metric, at least one resource of the sidelink resource pool to determine the competition level metric for the shared resource band, and means for transmitting one or more reservations for reserving one or more resources of the sidelink resource pool based at least on part on the competition level metric.

A non-transitory computer-readable medium storing code for wireless communication of a UE operating using a first RAT is described. The code may include instructions executable by a processor to identify a sidelink resource pool of a shared resource band and a parameter of a competition level metric for measuring communication activity in the shared resource band, the shared resource band associated with communication by the first RAT and a second RAT that differs from the first RAT, monitor, in accordance with the parameter of the competition level metric, at least one resource of the sidelink resource pool to determine the competition level metric for the shared resource band, and transmit one or more reservations for reserving one or more resources of the sidelink resource pool based at least on part on the competition level metric.

In some examples of the method, apparatuses, and non-transitory computer-readable medium described herein, identifying the sidelink resource pool and the parameter of the competition level metric may include operations, features, means, or instructions for receiving control signaling that indicates the sidelink resource pool and the parameter of the competition level metric.

Some examples of the method, apparatuses, and non-transitory computer-readable medium described herein may further include operations, features, means, or instructions for selecting a number of reservations to send based on the competition level metric, where transmitting the one or more reservations includes transmitting one or more reservations for reserving the one or more resources of the sidelink resource pool in accordance with the number of reservations.

Some examples of the method, apparatuses, and non-transitory computer-readable medium described herein may further include operations, features, means, or instructions for mapping the competition level metric to the number of reservations from a set of multiple different numbers of resource reservations, where selecting the number of reservations may be based at least in part the mapping.

In some examples of the method, apparatuses, and non-transitory computer-readable medium described herein, transmitting the one or more reservations may include operations, features, means, or instructions for transmitting at least one of the one or more reservations that includes a reservation reliability indicator that may be based on the competition level metric.

Some examples of the method, apparatuses, and non-transitory computer-readable medium described herein may further include operations, features, means, or instructions for mapping the competition level metric to the reservation reliability indicator from a set of reservation reliability indicators, where the reservation reliability indicator may be based on the mapping.

In some examples of the method, apparatuses, and non-transitory computer-readable medium described herein, the reservation reliability indicator may be associated with resource selection within the sidelink resource pool by one or more other UEs.

Some examples of the method, apparatuses, and non-transitory computer-readable medium described herein may further include operations, features, means, or instructions for mapping the competition level metric to a resource reservation restriction of a set of multiple resource reservation restrictions, where transmitting the one or more reservations for reserving the one or more resources of the sidelink resource pool may be based on the resource reservation restriction.

Some examples of the method, apparatuses, and non-transitory computer-readable medium described herein may further include operations, features, means, or instructions for determining a signal strength associated with the second RAT at one or more measurement periods associated with the sidelink resource pool, where the parameter of the competition level metric indicates that the competition level metric includes the signal strength.

In some examples of the method, apparatuses, and non-transitory computer-readable medium described herein, each of the one or more measurement periods includes a respective gap symbol of a respective sidelink slot, the respective gap symbol other than symbols used for sidelink transmissions by the first RAT.

In some examples of the method, apparatuses, and non-transitory computer-readable medium described herein, each of the one or more measurement periods includes a respective sidelink slot configured for measurement of the signal strength, the respective sidelink slot other than slots used for sidelink transmissions by the first RAT.

Some examples of the method, apparatuses, and non-transitory computer-readable medium described herein may further include operations, features, means, or instructions for determining a second signal strength associated with the second RAT over a first slot other than a slot in which SCI may be decoded.

Some examples of the method, apparatuses, and non-transitory computer-readable medium described herein may further include operations, features, means, or instructions for determining a ratio of failed clear channel assessment (CCA) procedures within the sidelink resource pool of the shared resource band over a time period, where the parameter of the competition level metric indicates that the competition level metric includes the ratio.

In some examples of the method, apparatuses, and non-transitory computer-readable medium described herein, the ratio of failed CCA procedures may be based on one or more CCA procedures other than CCA procedures performed for sidelink resources selected for communication by the UE.

In some examples of the method, apparatuses, and non-transitory computer-readable medium described herein, the ratio of failed CCA procedures may be associated with CCA procedures performed for a channel access priority class corresponding to the sidelink resource pool.

Some examples of the method, apparatuses, and non-transitory computer-readable medium described herein may further include operations, features, means, or instructions for determining whether a CCA level associated with the second RAT satisfies a threshold at each of a set of measurement periods, where the ratio of failed CCA procedures may be based on CCA procedures associated with one or more measurement periods of the set of measurement periods in which the threshold may be satisfied.

In some examples of the method, apparatuses, and non-transitory computer-readable medium described herein, each of the set of measurement periods includes a respective gap symbol of a respective sidelink slot, the respective gap symbol other than symbols used for sidelink transmissions.

In some examples of the method, apparatuses, and non-transitory computer-readable medium described herein, each of the set of measurement periods includes a respective sidelink slot configured for measurement of the CCA level associated with the second RAT, the respective sidelink slot other than slots used for sidelink transmissions.

Some examples of the method, apparatuses, and non-transitory computer-readable medium described herein may further include operations, features, means, or instructions for determining whether a CCA level associated with the second RAT satisfies a threshold over a first slot other than a slot in which SCI may be decoded, where the ratio of failed CCA procedures may be based on a CCA procedure associated with the first slot in which the threshold may be satisfied.

A method for wireless communication of a first UE operating using a first RAT is described. The method may include identifying a sidelink resource pool of a shared resource band and a parameter of a competition level metric for measuring communication activity in the shared resource band, the shared resource band associated with communication by the first RAT and a second RAT that differs from the first RAT and receiving, from a second UE, an indication of one or more reservations for reserving one or more resources of the sidelink resource pool, the one or more reservations indicative of the competition level metric for the second UE in the shared resource band.

An apparatus for wireless communication of a first UE operating using a first RAT is described. The apparatus may include a processor, memory coupled with the processor, and instructions stored in the memory. The instructions may be executable by the processor to cause the apparatus to identify a sidelink resource pool of a shared resource band and a parameter of a competition level metric for measuring communication activity in the shared resource band, the shared resource band associated with communication by the first RAT and a second RAT that differs from the first RAT and receive, from a second UE, an indication of one or more reservations for reserving one or more resources of the sidelink resource pool, the one or more reservations indicative of the competition level metric for the second UE in the shared resource band.

Another apparatus for wireless communication of a first UE operating using a first RAT is described. The apparatus may include means for identifying a sidelink resource pool of a shared resource band and a parameter of a competition level metric for measuring communication activity in the shared resource band, the shared resource band associated with communication by the first RAT and a second RAT that differs from the first RAT and means for receiving, from a second UE, an indication of one or more reservations for reserving one or more resources of the sidelink resource pool, the one or more reservations indicative of the competition level metric for the second UE in the shared resource band.

A non-transitory computer-readable medium storing code for wireless communication of a first UE operating using a first RAT is described. The code may include instructions executable by a processor to identify a sidelink resource pool of a shared resource band and a parameter of a competition level metric for measuring communication activity in the shared resource band, the shared resource band associated with communication by the first RAT and a second RAT that differs from the first RAT and receive, from a second UE, an indication of one or more reservations for reserving one or more resources of the sidelink resource pool, the one or more reservations indicative of the competition level metric for the second UE in the shared resource band.

In some examples of the method, apparatuses, and non-transitory computer-readable medium described herein, identifying the sidelink resource pool and the parameter of the competition level metric may include operations, features, means, or instructions for receiving control signaling that indicates the sidelink resource pool and the parameter of the competition level metric.

In some examples of the method, apparatuses, and non-transitory computer-readable medium described herein, a number of the one or more reservations may be associated with the competition level metric for the second UE.

In some examples of the method, apparatuses, and non-transitory computer-readable medium described herein, the number of the one or more reservations may be based at least in part a mapping between the competition level metric and the number of the one or more reservations.

In some examples of the method, apparatuses, and non-transitory computer-readable medium described herein, receiving the one or more reservations may include operations, features, means, or instructions for receiving at least one of the one or more reservations that includes a reservation reliability indicator that may be based on the competition level metric.

In some examples of the method, apparatuses, and non-transitory computer-readable medium described herein, the reservation reliability indicator may be based at least in part a mapping between the competition level metric and the reservation reliability indicator.

Some examples of the method, apparatuses, and non-transitory computer-readable medium described herein may further include operations, features, means, or instructions for selecting one or more second resources within the sidelink resource pool based on the reservation reliability indicator.

In some examples of the method, apparatuses, and non-transitory computer-readable medium described herein, the competition level metric may be associated with a resource reservation restriction of a set of multiple resource reservation restrictions based on a mapping between the competition level metric and the resource reservation restriction.

In some examples of the method, apparatuses, and non-transitory computer-readable medium described herein, the parameter of the competition level metric indicates that the competition level metric includes a signal strength associated with the second RAT measured at one or more measurement periods associated with the sidelink resource pool.

In some examples of the method, apparatuses, and non-transitory computer-readable medium described herein, each of the one or more measurement periods includes a respective gap symbol of a respective sidelink slot, the respective gap symbol other than symbols used for sidelink transmissions by the first RAT.

In some examples of the method, apparatuses, and non-transitory computer-readable medium described herein, each of the one or more measurement periods includes a respective sidelink slot configured for measurement of the signal strength, the respective sidelink slot other than slots used for sidelink transmissions by the first RAT.

In some examples of the method, apparatuses, and non-transitory computer-readable medium described herein, the competition level metric may be associated with determining a second signal strength associated with the second RAT over a first slot other than a slot in which SCI may be decoded.

In some examples of the method, apparatuses, and non-transitory computer-readable medium described herein, the parameter of the competition level metric indicates that the competition level metric includes a ratio of failed CCA procedures within the sidelink resource pool of the shared resource band over a time period.

In some examples of the method, apparatuses, and non-transitory computer-readable medium described herein, the ratio of failed CCA procedures may be based on one or more CCA procedures other than CCA procedures performed for sidelink resources.

In some examples of the method, apparatuses, and non-transitory computer-readable medium described herein, the ratio of failed CCA procedures may be associated with CCA procedures performed for a channel access priority class corresponding to the sidelink resource pool.

In some examples of the method, apparatuses, and non-transitory computer-readable medium described herein, the ratio of failed CCA procedures may be based on CCA procedures associated with one or more measurement periods of a set of measurement periods in which threshold may be satisfied by a CCA level associated with the second RAT.

In some examples of the method, apparatuses, and non-transitory computer-readable medium described herein, each of the set of measurement periods includes a respective gap symbol of a respective sidelink slot, the respective gap symbol other than symbols used for sidelink transmissions.

In some examples of the method, apparatuses, and non-transitory computer-readable medium described herein, each of the set of measurement periods includes a respective sidelink slot configured for measurement of the CCA level associated with the second RAT, the respective sidelink slot other than slots used for sidelink transmissions.

In some examples of the method, apparatuses, and non-transitory computer-readable medium described herein, the ratio of failed CCA procedures may be based on a CCA procedure associated with a first slot other than a slot in which SCI may be decoded in which the threshold may be satisfied by a CCA level associated with the second RAT.

### BRIEF DESCRIPTION OF THE DRAWINGS

FIG. 1 illustrates an example of a wireless communications system that supports sidelink resource reservation in a shared band in accordance with one or more aspects of the present disclosure.

FIG. 2 illustrates an example of a resource selection scheme that supports sidelink resource reservation in a shared band in accordance with one or more aspects of the present disclosure.

FIG. 3 illustrates an example of a wireless system that supports sidelink resource reservation in a shared band in accordance with one or more aspects of the present disclosure.

FIG. 4 illustrates an example of a resource selection scheme that supports sidelink resource reservation in a shared band in accordance with one or more aspects of the present disclosure.

FIG. 5 illustrates an example of a resource selection scheme that supports sidelink resource reservation in a shared band in accordance with one or more aspects of the present disclosure.

FIG. 6 illustrates an example of a resource selection scheme that supports sidelink resource reservation in a shared band in accordance with one or more aspects of the present disclosure.

FIG. 7 illustrates an example of a resource selection scheme that supports sidelink resource reservation in a shared band in accordance with one or more aspects of the present disclosure.

FIG. 8 illustrates an example of a resource selection scheme that supports sidelink resource reservation in a shared band in accordance with one or more aspects of the present disclosure.

FIG. 9 illustrates an example of a mapping that supports sidelink resource reservation in a shared band in accordance with one or more aspects of the present disclosure.

FIG. 10 illustrates an example of a resource selection scheme that supports sidelink resource reservation in a shared band in accordance with one or more aspects of the present disclosure.

FIG. 11 illustrates an example of a wireless system that supports sidelink resource reservation in a shared band in accordance with one or more aspects of the present disclosure.

FIG. 12 illustrates an example of a process flow that supports sidelink resource reservation in a shared band in accordance with one or more aspects of the present disclosure.

FIGS. 13 and 14 show block diagrams of devices that support sidelink resource reservation in a shared band in accordance with one or more aspects of the present disclosure.

FIG. 15 shows a block diagram of a communications manager that supports sidelink resource reservation in a shared band in accordance with one or more aspects of the present disclosure.

FIG. 16 shows a diagram of a system including a device that supports sidelink resource reservation in a shared band in accordance with one or more aspects of the present disclosure.

FIGS. 17 through 20 show flowcharts illustrating methods that support sidelink resource reservation in a shared band in accordance with one or more aspects of the present disclosure.

### DETAILED DESCRIPTION

In some wireless communications systems, a sidelink user equipment (UE) may communicate with one or more other sidelink UEs on an unlicensed sidelink (SL-U) band, which may also be used by one or more other radio access technologies (RATs). In some examples (e.g., in Mode 2 resource allocation), the UE may select one or more future resources for transmission of sidelink data, and the UE may indicate reservation of the selected resource(s) by transmitting a resource reservation via sidelink control information (SCI). For example, the UE may select and reserve two resources for future transmission(s), or some other number of resources indicated by a resource pool configuration, and may indicate the reserved resource(s) in SCI. Other UEs may use the SCI to identify available and unavailable resources during a sensing window. In some examples, the UE may perform a listen before talk (LBT) based channel access (e.g., clear channel assessment (CCA) based channel access) on the reserved resource(s) (e.g., before transmitting using the resource(s)), which may be impacted by one or more other competing RATs. For example, a sidelink UE may select one or more resources for sidelink transmissions, and the resources may be occupied or used by another RAT (e.g., as indicated by an LBT or CCA procedure), such that the reservation may be relatively unreliable. For example, one or more resources may be reserved by the UE, but may not be used by the UE (e.g., as a result of the LBT procedure), which may result in reduced resource reservation reliability and channel access inefficiency.

Techniques, systems, and devices are described herein to support sidelink resource reservation based on a competition level associated with one or more other RATs in an unlicensed band. For example, UEs operating in an unlicensed sidelink band (e.g. SL-U band) may determine a competition level from one or more other RATs, and may reserve resources in a sidelink resource pool based on the based on the determined competition level. For example, the UEs may determine a signal strength associated with the other RAT(s), or may determine a ratio of failed LBT procedures, or both, based on monitoring one or more resources of the sidelink resource pool. Based on the determined competition level, the UEs may select a number of resources to reserve using SCI, or may transmit an indication of a reservation reliability with a resource reservation (e.g., among other examples).

For example, if a UE determines a higher competition level, the UE may transmit an SCI that includes a fewer number of reservations (e.g., one reservation, fewer than a number of reservations configured for the resource pool), and if the UE determines a lower competition level, the UE may transmit an SCI that includes a higher number of reservations (e.g., two reservations, a number of reservations configured for the resource pool). Resource reservation based on the competition level may result in increased efficiency and increased resource reservation reliability.

Aspects of the disclosure are initially described in the context of wireless communications systems. Aspects of the disclosure are additionally described in the context of resource selection schemes and a mapping. Aspects of the disclosure are further illustrated by and described with reference to apparatus diagrams, system diagrams, and flowcharts that relate to techniques for scheduling across multiple cells.

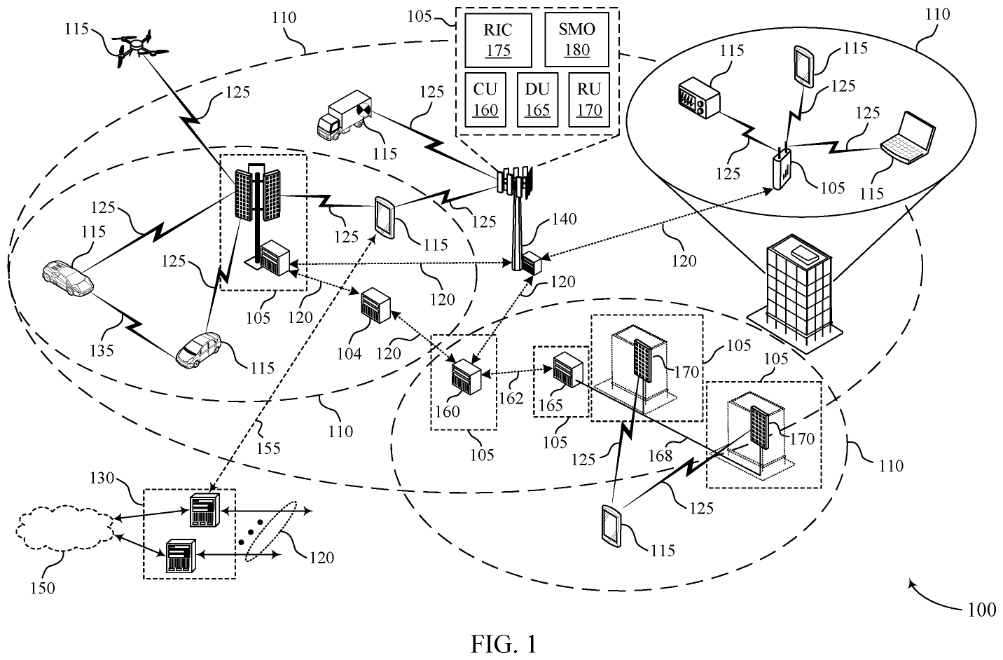

FIG. 1 illustrates an example of a wireless communications system 100 that supports sidelink resource reservation in a shared band in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support sidelink resource reservation in a shared band as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

One or more sidelink UEs 115 may determine a competition level associated with one or more other RATs when operating in an unlicensed band. For example, UEs 115 operating in an unlicensed sidelink band (e.g. SL-U UEs 115) may determine a competition level from one or more RATs and reserve resources in a sidelink resource pool based on the determined competition level. For example, the UEs 115 (e.g., one or more of the UEs 115) may determine a signal strength associated with the other RAT(s), or may determine a ratio of failed LBT procedures, based on monitoring one or more resources of the sidelink resource pool. Based on the determined competition level, the UEs may select a number of resources to reserve using SCI, or may indicate a reliability level of the reserved resources in the SCI, or both.

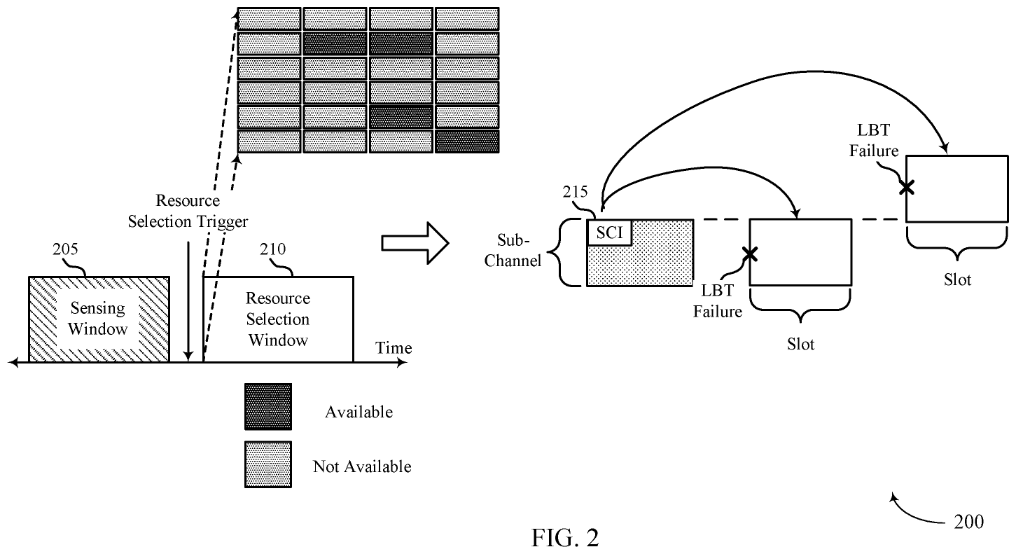

FIG. 2 illustrates an example of a resource selection scheme 200 that supports sidelink resource reservation in a shared band in accordance with one or more aspects of the present disclosure. Resource selection scheme 200 may implement, or be implemented by, one or more aspects of wireless communications system 100 and may support sidelink communications between devices. For example, resource selection scheme 200 may be implemented by one or more UEs 115 as described with reference to FIG. 1. Within sidelink communications, a device (e.g., UE 115) may communicate using a licensed band or an unlicensed band. For example, some new radio (NR) sidelink communications may include exchanging short messages among nearby UEs 115 (e.g., vehicular UEs 115) over sub-7 GHz intelligent transportation system (ITS) bands and/or licensed bands.

A UE 115 that operates on a sidelink licensed band may, in some cases, use a resource allocation Mode 2 (e.g., for autonomous deployment, autonomous resource selection). Upon occurrence of a resource selection trigger, a transmitting UE may perform sensing (e.g., physical (PHY) layer sensing) in a sensing window 205 to identify a set of sidelink resources that may be available (e.g., not reserved by other UEs 115) in a resource selection window 210. Within the set of available resources, a MAC layer of the UE 115 may randomly select resources (e.g., up to three resources) for sidelink channel access. The transmitting UE may transmit SCI 215 to indicate an occupancy of a current sub-channel (e.g., a sub-channel used for transmission of the SCI 215) and reservation of one or more future sub-channels (e.g., up to two future sub-channels). The reservation information (e.g., in the SCI 215) may be used by other sensing UEs 115 (e.g., in a respective sensing window 205) to identify available and unavailable resources.

A sidelink resource reservation (e.g., nearby reservation) made by a first UE 115 may be respected by a second UE 115, for example, if enough sidelink resources are identified by a PHY layer of the second UE 115 as being available for selection by a MAC layer of the second UE 115. If there are insufficient (e.g., not enough) available resources, the PHY layer of the second UE 115 may relax a signal strength (e.g., reference signal received power (RSRP)) threshold to identify (e.g., mark) one or more reserved resources (e.g., additional reserved resources) as available (e.g., which may be referred to as “over-booking” sidelink resources to support spatial re-use, such as a reasonable spatial re-use).

Sidelink communications may support signaling between various devices (e.g., in one or more domains, such as vertical domains). For example, sidelink communications may support V2X signaling (e.g., between vehicle UEs 115, between vehicle UEs 115 and other UEs 115), DRX communications (e.g., for battery-powered UEs 115), and other inter-UE coordination (e.g., for higher reliability in Mode 2 communications). In some cases, some sidelink signaling (e.g., for various vertical domains) may not have access to sub-7 GHz ITS bands and/or licensed bands. Accordingly, some sidelink communications (e.g., Mode 1 and/or Mode 2 communications) may be deployed over other frequency bands, such as in unlicensed spectrum (e.g., frequency range 1 (FR1) unlicensed spectrum). Such sidelink communications may be associated with one or more sidelink operations, sidelink channel access mechanisms, channel structures, and/or channel procedures for operation in the unlicensed spectrum. For example, in some cases, UE operation (e.g., direct link to a network entity 105) in Mode 1 communications may be limited to licensed spectrum.

In some sidelink communications over an unlicensed band (e.g., sidelink-unlicensed (SL-U), in an FR1 band), a transmitting UE 115 may perform resource reservation according to an LBT-based channel access, which may be impacted by other competing RATs (e.g., Wi-Fi, LTE Authorization Authentication and Accounting (LTE-AAA), NR-unlicensed (NR-U)). For example, if reservation signaling may be considered relatively reliable (e.g., reliably reserve resources, such that a transmitting UE 115 may be more likely to transmit over reserved resources), channel access (e.g., channel access efficiency) may be increased (e.g., among other benefits). However, in some examples (e.g. in the SL-U band), LBT procedures may make some resource reservations less reliable (e.g., unreliable). For example, a transmitting UE 115 may be blocked by an LBT (e.g., a result of an LBT procedure) and may be unable to transmit using one or more reserved resources.

An unreliability of a resource reservation may be increased (e.g., a problem of unreliable reservation may be exacerbated), for example, if reservation of multiple sidelink resources (e.g., more than two resources, much more than two resources) per SCI is supported. Such reservations may be supported for channel occupancy time (COT) based transmissions (e.g., to facilitate COT transmissions) or to reduce LBT uncertainty for multiple resource reservation opportunities. For example, in some cases (e.g., in heavy loading cases), a sensing UE 115 may identify a limited number of available sub-channels using one or more non-relaxed RSRP thresholds and may therefore relax the RSRP threshold(s) to identify additional available sub-channels. However, the UE 115 may be unable to differentiate between reserved resources (e.g., other than the RSRP threshold(s)) in terms of reservation reliability. For example, the UE 115 (e.g., and other UEs 115) may be unable to determine a reliability of the reserved resources (e.g., determine whether the resources may or may not remain reserved, based on one or more other RATs using the resources).

In some examples, resource reservations may have different reliabilities (e.g., with respect to a probability of being blocked by an LBT failure), which may be based on a presence of active competition from other RATs (e.g., Wi-Fi, LTE-AAA, NR-U). Techniques described herein may support increasing a reliability of resource reservations.

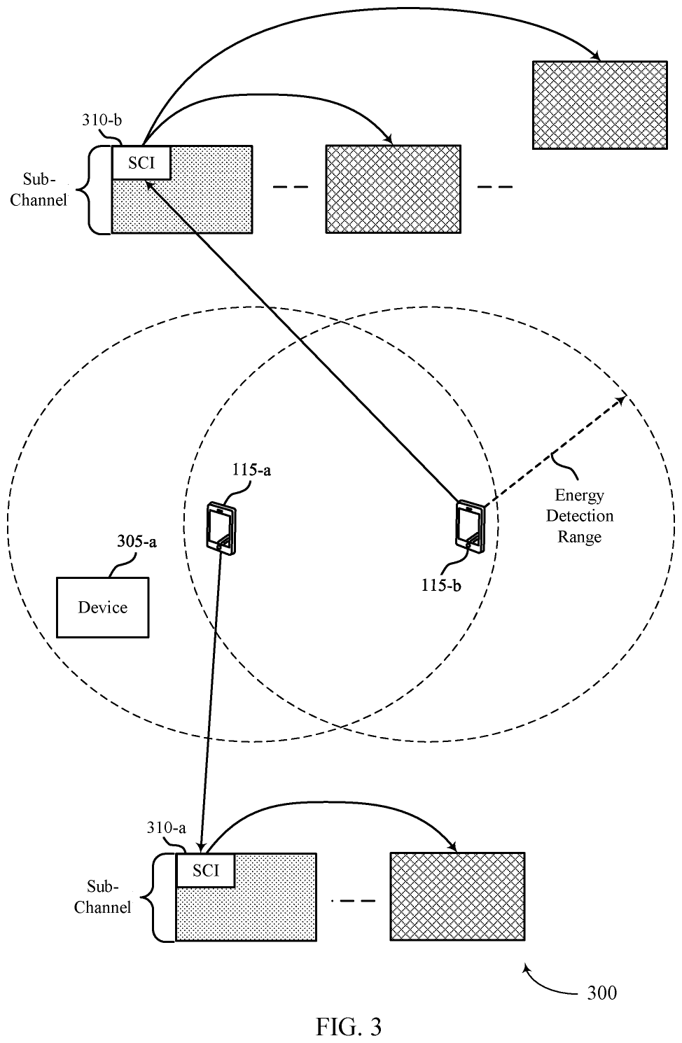

FIG. 3 illustrates an example of a wireless communications system 300 that supports sidelink resource reservation in a shared band in accordance with one or more aspects of the present disclosure. Wireless communications system 300 may implement, or be implemented by, one or more aspects of wireless communications system 100 or resource selection scheme 200 and may support sidelink communications between devices. For example, wireless communications system 300 may be implemented by one or more UEs 115 as described with reference to FIG. 1. For example, as described with reference to FIG. 2, a UE 115-a or a UE 115-b that operates on a sidelink band (e.g., a sidelink licensed band, a sidelink unlicensed band) may identify resources to use for a sidelink transmission based on a channel sensing procedure. Based on the resource identification, the UE 115-a may transmit SCI (e.g., SCI 310-a) to indicate an occupancy of a current sub-channel and reservation of one or more future sub-channels. In some examples (e.g., in SL-U), the UE 115-a may perform resource reservation according to LBT-based channel access, which may be impacted by one or more other competing RATs, such as a device 305-a using a different RAT (e.g., a Wi-Fi access point, a base station, a network device). For example, LBT procedures may make some resource reservations less reliable, such as if the UE 115-a may be blocked by the LBT procedure (e.g., by a failed LBT procedure, based on another competing RAT) and may be unable to transmit using one or more reserved resources.

An unreliability of a resource reservation may be increased if reservation of multiple sidelink resources (e.g., more than two resources, much more than two resources, or both) per SCI 310 is supported in SL-U. For example, resource reservations may have different reliabilities (e.g., with respect to a probability of being blocked by an LBT failure), which may be based on a presence of active competition from other RAT(s), where some resource reservations may be less reliable (e.g., may be relatively unreliable) based on the presence of, and competition from, one or more other RATs.

Techniques described herein may support increasing a reliability of sidelink resource reservations, such as in SL-U. In order to support increasing the reliability of resource reservations, the UE 115-a (e.g., among other UEs 115, such as the UE 115-b) may perform an LBT-restricted reservation. The LBT-restricted reservation may include one or more restrictions for UEs 115 sending one or more resource reservations based on how UE 115-a may be impacted by one or more other RATs, such as device 305-a (e.g., using a second RAT), that may be attempting to compete for resources and channel access (e.g., with LBT or CCA procedures). For example, the UE 115-a compete with the device 305-a (e.g., a WiFi access point) for channel access (e.g., both devices may attempt to reserve resources from a same resource pool). Based on the competition from the other RAT (e.g., from device 305-a), the UE 115-a may be restricted to reserve one resource per SCI 310. Alternatively, the UE 115-b may be out of an energy detection range of device 305-a (e.g., out of a wireless range, not competing for at least some wireless resources). Because UE 115-b may not compete with the device 305-a for channel access (e.g., may not attempt to reserve resources from the same resource pool as the device 305-a), the UE 115-b may reserve up to two resources per SCI 310.

In some examples, the UE 115-a may determine whether one or more other RATs, such as device 305-a (e.g., using another RAT), are attempting to compete for resources in the same resource pool (e.g., may learn a competition level from other RAT(s)) by measuring a signal strength (e.g., a received signal strength indicator (RSSI)) over a gap time period (e.g., a measurement hole), which may be defined for each resource pool (e.g., arranged by resource pool). At the gap time period, other sidelink UEs 115 in the unlicensed band (e.g., all SL-U UEs 115), such as UE 115-b, may refrain from transmitting (e.g., other UEs 115, such as UE 115-b, may be silent at the defined measurement holes, such that any transmissions over the measurement holes may be due to other RAT(s)). Additionally or alternatively, the UE 115-a may determine whether one or more RATs, such as wireless device 305-a, are competing for resources in the same resource pool (e.g., may learn a competition level from other RAT(s)) by measuring and recording an LBT failure ratio (e.g., a CCA failure ratio).

In some examples, the UE 115-a may measure both the signal strength and the LBT failure ratio, such that a metric indicating the competition level from other RAT(s) may be a combination of the signal strength and the LBT failure ratio. As such, the LBT failure ratio and the signal strength may be used to determine competition from one or more other RATs for selecting a number of reservations to include in SCI. In some cases, each channel access priority class (CAPC) may be associated with one or more respective combinations of signal strength and LBT failure ratio for determining the competition level from the other RAT(s).

In additionally or as an alternative to restricting an amount of resource reservations, an LBT-restricted reservation may include restrictions on whether the UE 115-a may reserve a COT for continuous transmissions (e.g., whether to allow the UE 115-a to reserve a COT), whether the UE 115-a may reserve an earlier starting point when cyclic prefix (CP) extension is used (e.g., whether to allow reserving the earlier starting point), or both.

When accessing a resource pool (e.g., the resource pool specified over an unlicensed band and associated with LBT procedures), the UE 115-a (e.g., among other UEs 115 accessing the resource pool) may be configured to measure a competition level metric (e.g., a signal strength, an LBT failure ratio, or both) when, or before, attempting to reserve a resource (e.g., accessing the resource pool). The competition level metric may reflect a competition level from one or more other RATs, and the UE 115-a may use the competition level metric to determine how to send one or more resource reservations. For example, the resource pool may configure the UE 115-a with a competition level metric for the UE 115-a to measure (e.g., the UE 115-a may obtain the metric based on the configuration of the resource pool) when the UE 115-a attempts to reserve resources. Additionally, the resource pool may configure the UE 115-a with a mapping from the measured competition level metric to a set of resource reservation approaches (e.g., a number of resources the UE 115-a may reserve, whether a COT reservation is permitted, whether an earlier starting point is permitted) based on the measured competition level metric.

The UE 115-a may measure the competition level based on the indicated competition level metric. When performing resource reservation (e.g., when the UE 115-a determines to reserve resources), the UE 115-a may check the competition level metric and the UE 115-a may determine the set of resource reservation approaches, for example, using the mapping and based on the competition level metric. The UE 115-a may transmit one or more resource reservations (e.g., an allowed number of resource reservations) in an SCI 310-a to inform other UEs, such as UE 115-b, of the reservation(s).

For example, in some cases, a UE 115 (e.g., UE 115-a or UE 115-b) may reserve a first number of resources per SCI (e.g., two resources), but to make the resource reservation more reliable, the UE 115 may reserve fewer than the first number of resources if the UE 115 detects competition from the one or more RATs. As such, the UE 115 may determine a number of reservations per SCI the UE 115 is permitted to make based on observed competition from the one or more RATs. In one example, the UE 115-a may measure a configured competition level metric (e.g., configured for the resource pool) and determine, based on a mapping associated with the resource pool a number of resources that may be reserved by the UE 115-a. For example, if the competition level metric is relatively higher, the UE 115-a may (e.g., may be allowed to) reserve one resource per SCI 310 (e.g., or in some cases, no resources may be reserved), and if the competition level is relatively lower, the UE 115-a may (e.g., may be allowed to) reserve two resources per SCI 310. In this example, the configured competition level metric may indicate that other RATs, such as device 305-a, are attempting to compete for resources in the same resource pool (e.g. the UE 115-a may be measuring a relatively high competition level from a device 305-a).

Similarly, the UE 115-b may measure the configured competition level metric (e.g., configured for a same resource pool, a different resource pool), and determine, based on an associated mapping, that the UE 115-b may (e.g., may be allowed to) reserve two resources per SCI 310 (e.g., based on a lower competition level metric). In this case, the configured metric may indicate that other RATs, such as device 305-a (e.g., using another RAT), are not attempting to compete for resources in the same resource pool (e.g., due to being out of a range from the UE 115-b).

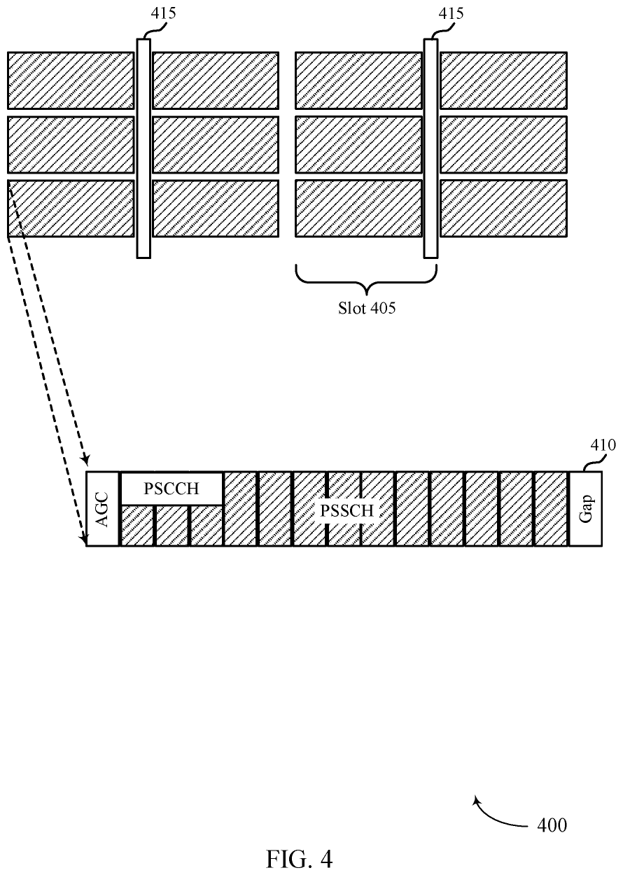

FIG. 4 illustrates an example of a resource selection scheme 400 that supports sidelink resource reservation in a shared band in accordance with one or more aspects of the present disclosure. Resource selection scheme 400 may implement, or be implemented by, one or more aspects of wireless communications system 100, resource selection scheme 200, or wireless communications system 300, and may support sidelink communications between devices. For example, resource selection scheme 400 may be implemented by one or more UEs 115 as described with reference to FIGS. 1-3. For example, as described with reference to FIG. 3, a UE 115 that operates on a sidelink band (e.g., sidelink unlicensed band) may perform an LBT-restricted reservation based on a value of a competition level metric (e.g., to determine whether one or more other RATs are attempting to compete for resources in a same resource pool).

In some examples, the UE 115 may determine the competition level metric by measuring a signal strength (e.g., RSSI) over a gap time period, such as a gap symbol 410. For example, the competition level metric may be indicated as RSSI measured over a gap symbol 410 in each sidelink slot 405. Each sidelink slot 405 may, for example, include a gap symbol 410, which may be used for transmission and reception switching. When the gap symbol 410 is used in this way (e.g., for transmission and reception switching), other sidelink UEs 115 (e.g., all sidelink unlicensed UEs 115) may refrain from transmitting in the gap symbol 410 (e.g., may be silent in the gap symbol 410). As such, the gap symbol 410 may be used by the UE 115 (e.g., among other sidelink UEs 115) as a hole (e.g., sidelink transmission hole, gap) to measure a presence of other RAT(s) (e.g., to measure the competition level metric during the time period over the gap symbol 410). In some examples, the UE 115 (e.g., the UE 115-a as described with reference to FIG. 3) may measure a higher RSSI than a second sidelink UE 115 (e.g., the UE 115-b as described with reference to FIG. 3), and a threshold with respect to RSSI (e.g., for mapping to a set of resource reservation approaches) may lead to different resource reservation behaviors for the UE 115 and the second UE 115 (e.g., as described with reference to FIG. 3).

In some cases, in order to support continuous transmission at a sidelink slot 405 (e.g., inter-slot continuous transmission), a sidelink UE 115 (e.g., the UE 115, an SL-U UE 115) may perform CP extension from an automatic gain control (AGC) symbol, which may reduce a transmission gap of the gap symbol 410 to less than or equal to 16 microseconds (μs). In such cases, the resource pool may specify (e.g., a configuration of the resource pool may specify) that any CP extension is to leave a specified gap in the gap symbol 410 for measuring the competition level metric (e.g., a gap, or measurement hole, of less than or equal to 16 μs). In some cases, if a larger measurement hole is used (e.g., more than 16 μs), the resource pool (e.g., a configuration of the resource pool) may specify one or more slot indices, in which CP extension may be prohibited. Such slots 405 may, for example, be slots indicated as having gap symbols 415, which may be prohibited (e.g., limited) from CP extension.

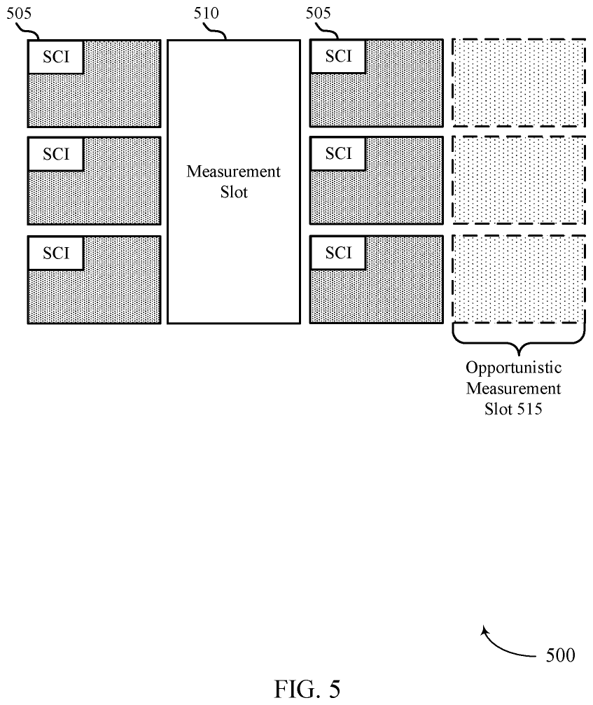

FIG. 5 illustrates an example of a resource selection scheme 500 that supports sidelink resource reservation in a shared band in accordance with one or more aspects of the present disclosure. Resource selection scheme 500 may be implemented by one or more UEs 115, as described with reference to FIGS. 1-4. For example, as described with reference to FIG. 3, a UE 115 that operates on a sidelink band (e.g., sidelink unlicensed band) may perform an LBT-restricted reservation based on a value of a competition level metric (e.g., to determine whether one or more other RATs are attempting to compete for resources in a same resource pool).

In some examples, the UE 115 may determine the competition level metric by measuring a signal strength (e.g., RSSI) over a gap time period, such as a gap symbol as described with reference to FIG. 4. The gap time period may be used by the UE 115 (e.g., among other sidelink UEs 115) as a hole (e.g., sidelink transmission hole, gap) to measure a presence of other RAT(s) (e.g., to measure the competition level metric during the time period over the gap time period).

However, in some examples, the RSSI measured over a gap symbol, or other relatively shorter time period, may not indicate a competition level from other RATs (e.g., may not be able to capture channel access attempts from other RATs) with a relatively low CAPC. For example, in some sub-carrier spacings (e.g., 30 kHz sub-carrier spacing), a gap symbol may be shorter than a time for detecting other wireless traffic or communications (e.g., the gap symbol may be approximately 35 μs and a deferral for best-effort traffic may be 43 μs). Therefore, a sidelink resource pool (e.g., a configuration of the resource pool) may indicate a measurement slot 510 (e.g., periodical slot) during which sidelink UEs 115 (e.g., all sidelink UEs 115) may be restricted from accessing transmission resources. As such, the UE 115 may measure the signal strength (e.g., RSSI) at the measurement slot 510. In some cases, the periodicity of the measurement slot 510 may be a relatively higher periodicity (e.g., a periodicity greater than or equal to 100 ms) to decrease (e.g., manage) overhead.

Additionally or alternatively, the UE 115 may opportunistically perform the signal strength measurement (e.g., opportunistically measure RSSI) over an opportunistic measurement slot 515, where an opportunistic measurement slot 515 may be a slot in which no SCI 505 is received from other UEs (e.g., no SCI 505 is decoded, indicating that no sidelink transmissions are taking place). In some cases, the UE 115 may use the opportunistic measurement slot 515 (e.g., to measure signal strength for determination of the competition level metric) when a periodicity of the measurement slot 510 is relatively large.

The UE 115 may use the RSSI measurement during the measurement slot 510, the opportunistic measurement slot 515, or both, together with a mapping associated with the resource pool to determine a set of resource reservation approaches for the UE 115.

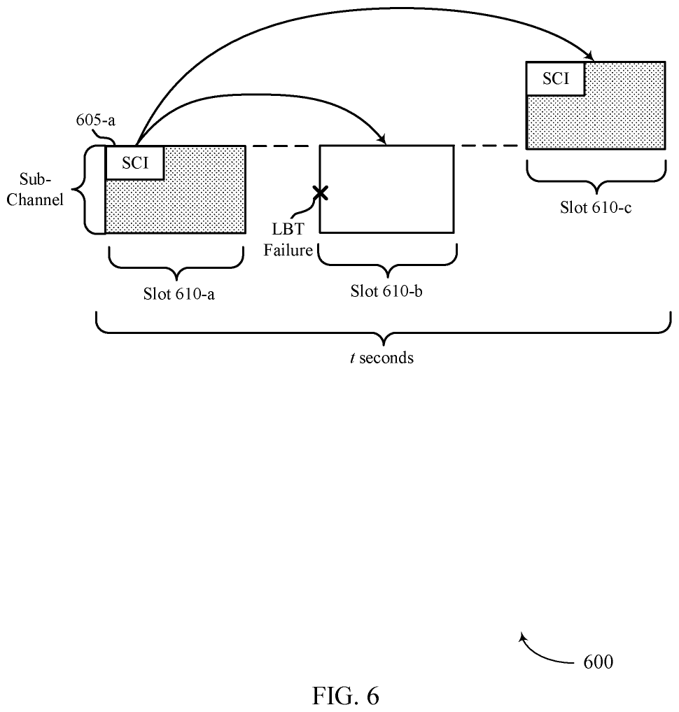

FIG. 6 illustrates an example of a resource selection scheme 600 that supports sidelink resource reservation in a shared band in accordance with one or more aspects of the present disclosure. Resource selection scheme 600 may be implemented by one or more UEs 115, which may be examples of UEs 115 as described with reference to FIGS. 1-5. For example, as described with reference to FIG. 3, a UE 115 that operates on a sidelink band (e.g., sidelink unlicensed band) may perform an LBT-restricted reservation based on a value of a competition level metric (e.g., to determine whether one or more other RATs are attempting to compete for resources in a same resource pool).

In some examples, the UE 115 may determine the competition level metric by measuring a signal strength (e.g., RSSI) over a gap time period. For example, the competition level metric may be an RSSI measured over a gap time period (e.g., as described with reference to FIGS. 4 and 5). Additionally or alternatively, the resource pool (e.g., a configuration of the resource pool) may indicate for the UE 115 to determine the competition level metric by measuring an LBT failure ratio (e.g., a CCA failure ratio) during a period of time (e.g., an LBT failure ratio recorded over a past t seconds), where the period of time may also be configured on a resource pool basis. For example, the UE 115 may measure a CCA failure ratio by determining the amount of LBT attempts (e.g., CCA attempts) by the UE 115 to reserve sidelink resources (e.g., counting the LBT attempts made for sidelink resources selected by the UE 115 MAC layer).

In one example, the UE 115 may perform an initial sidelink transmission in a first slot 610-a, for example, after performing a successful LBT or CCA procedure. The UE 115 may transmit SCI 605-a in slot 610-a to reserve future resources in slot 610-b and slot 610-c. In this example, transmissions associated with another RAT may occupy at least some of the resources of reserved slot 610-b, such that an LBT or CCA procedure performed by the UE 115 for slot 610-b results in an LBT failure (e.g., a CCA failure). An LBT or CCA procedure performed by the UE 115 for slot 610-c may result in an LBT success, such that slot 610-c may be available and may be used for communications by the UE 115. Based on the one failed transmission attempt and the two successful transmission attempts, the UE 115 may determine the CCA failure ratio (e.g., 1/3).

In some cases, the UE 115 may determine the CCA failure ratio (e.g., count the CCA failure ratio) by performing (e.g., the UE 115 may be permitted to perform) pseudo LBT or CCA attempts that may be unassociated with reserving sidelink resources. For example, in the example illustrated by FIG. 6, one or more of the sidelink transmissions (e.g., in slot 610-a, 610-b, 610-c, or any combination thereof) may be associated with LBT or CCA attempts that may be unassociated with resource reservation (e.g., the UE 115 may perform the LBT or CCA procedure, but may not attempt a transmission on the resources, even if the LBT or CCA procedure is successful).

In some examples, the CCA failure rate may be determined for each CAPC (e.g., may be recorded per CAPC). The UE 115 may use the CCA failure ratio and a mapping associated with the resource pool to a set of resource reservation approaches (e.g., to determine one or more resource reservation behaviors, such as a number of reservations per SCI 605). For example, for a relatively lower CCA failure ratio, the UE 115 may reserve two resources per SCI 605 (e.g., a highest amount of resources available for reservation by a UE 115 of the resource pool). Similarly, for a relatively higher CCA failure ratio, the UE 115 may reserve one resource (e.g., in some cases zero resources) per SCI 605 (e.g., a subset of the highest amount of resources configured for reservation by a UE 115 of the resource pool, a lower amount of resources). In cases where the failure ratio is determined per CAPC, the UE 115 may determine the set of resource reservation approaches based on the CCA failure ratio under the same CAPC (e.g., may determine and use one CCA failure ratio per CAPC).

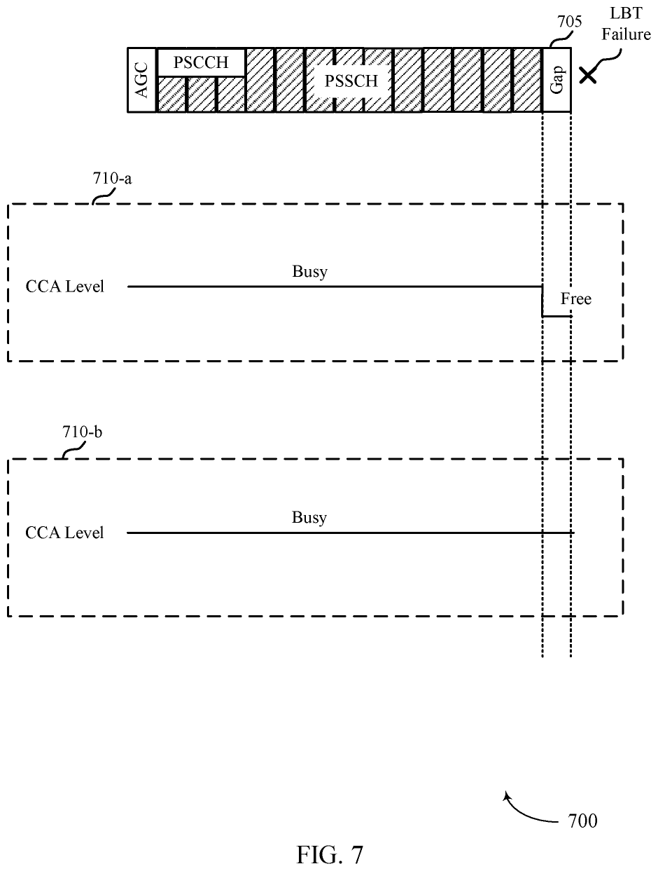

FIG. 7 illustrates an example of a resource selection scheme 700 that supports sidelink resource reservation in a shared band in accordance with one or more aspects of the present disclosure. Resource selection scheme 700 may be implemented by one or more UEs 115, which may be examples of UEs 115 as described with reference to FIGS. 1-6. For example, as described with reference to FIG. 3, a UE 115 that operates on a sidelink band (e.g., sidelink unlicensed band) may perform an LBT-restricted reservation based on a value of a competition level metric (e.g., to determine whether one or more other RATs are attempting to compete for resources in a same resource pool).

In some examples, the UE 115 may determine the competition level metric by measuring an LBT failure ratio (e.g., a CCA failure ratio), as described with reference to FIG. 6. In addition to indicating a measurement of the LBT failure ratio, the resource pool (e.g., a configuration of the resource pool) may indicate to determine the CCA failure ratio that is due to other RATs (e.g., not due to sidelink unlicensed UEs 115) by indicating for UEs 115 to measure a CCA level at a gap symbol 705 (e.g., the resource pool may request for the UE 115 to check the CCA level at gap symbols 705). For example, if the UE 115 performs an LBT procedure resulting in an LBT failure in a slot (e.g., an LBT attempt failed at a target instant), the UE 115 may determine (e.g., check) the CCA level(s) at the gap symbol 705 of the slot (e.g., may check one or more gap symbols 705). In such cases, the UE 115 may determine that the failure is due to competition from one or more other RATs if the CCA level is higher at the gap symbol(s) 705 (e.g., if B gap symbols 705 indicate a busy CCA level, where B is equal to or greater than one).

In one example illustrated by FIG. 7, an LBT duration may be one slot (e.g., may be within one slot) and the UE 115 may measure the CCA level in a gap symbol 705, to determine whether an LBT failure is due to one or more other RATs. In a first example of a CCA procedure 710-a, the UE 115 may detect a busy level until the gap symbol 705, during which the CCA level may indicate that the gap symbol is free. In such cases, the LBT failure may not be attributed to another RAT (e.g., may be attributed to another sidelink UE 115 operating in an unlicensed band), and the UE 115 may not use the LBT failure to determine the LBT failure ratio (e.g., the LBT failure may not count towards the LBT failure ratio). In a second example of a CCA procedure 710-b, the UE 115 may detect a busy level through and including the gap symbol 705. In such cases, the LBT failure may be attributed to another RAT, and the UE 115 may use the LBT failure to determine the LBT failure ratio (e.g., the LBT failure may count towards the LBT failure ratio).

In some cases, such as when inter-slot continuous transmission is supported, a sidelink UE 115 (e.g., the UE 115, an SL-U UE 115) may measure the CCA level (e.g., check the CCA level) during a specified gap (e.g., a measurement hole), such as at the gap symbol 705, or during a measurement slot. For example, in some cases, such as when the resource pool (e.g., a configuration of the resource pool) may indicate a measurement slot (e.g., periodical measurement slot) during which other sidelink UEs may not attempt to access transmission resources (e.g., SL-U UEs may be forbidden to access transmission resources) as described with reference to FIG. 5, the configuration of resource pool may additionally indicate for the UE 115 to measure the CCA levels over the measurement slot.

In such cases or in other cases in which SL-U exclusive slots may be configured, the UE 115 may determine, the resource pool configuration may further indicate for UEs 115 to check CCA levels in symbols of such a slot (e.g., check CCA levels in all symbols of an overlapping slot, within the LBT duration), for example, to support identification of whether the LBT failure is due to one or more other RATs. As described with reference to FIG. 6, the LBT failure ratio (e.g., due to the other RAT(s)) may be used to determine (e.g., estimate) a competition level metric associated with the other RAT(s), which competition level metric may be used to determine a number of resources to reserve (e.g., a set of resource reservation approaches). As such, the UE 115 may reserve the resource(s) based on the competition level metric, which may be based on LBT failure due to other RAT(s).

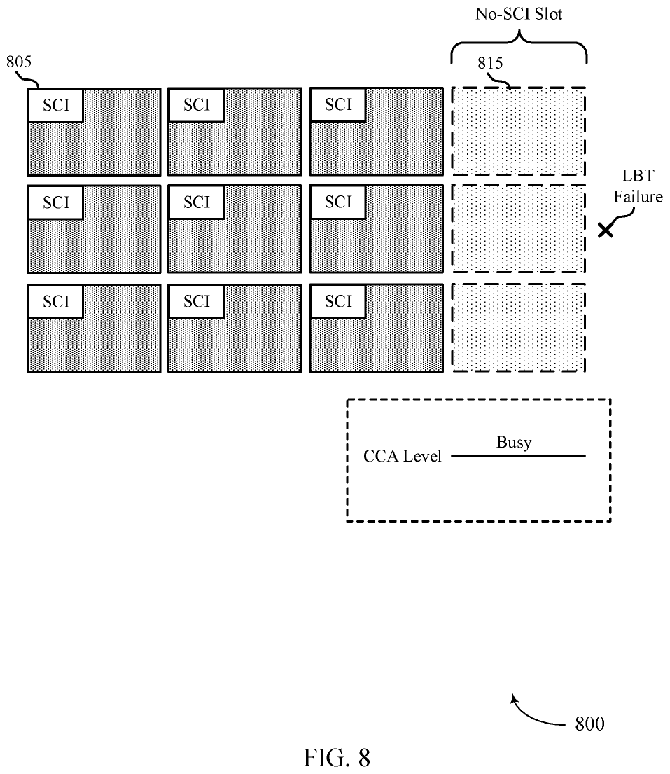

FIG. 8 illustrates an example of a resource selection scheme 800 that supports sidelink resource reservation in a shared band in accordance with one or more aspects of the present disclosure. Resource selection scheme 800 may be implemented by one or more UEs 115, which may represent one or more UEs 115 as described with reference to FIGS. 1-7. For example, as described with reference to FIGS. 3 and 7, a UE 115 that operates on a sidelink band (e.g., sidelink unlicensed band) may perform an LBT-restricted reservation based on a value of a competition level metric (e.g., to determine whether one or more other RATs are attempting to compete for resources in a same resource pool). As described with reference to FIG. 7, the UE 115 may determine the CCA level at a gap symbol to determine the competition level metric (e.g., a CCA failure ratio) based on LBT failure that is due to one or more other RATs.

In some examples, the resource pool (e.g., a configuration of the resource pool) may additionally indicate to measure (e.g., check) CCA levels in one or more sidelink slots 815 free of transmission of SCI 805 (e.g., a no-SCI slot 815) by other UEs 115 (e.g., other SL-U UEs 115). Such a slot may be at least partially within an LBT duration and may be similar to the opportunistic measurement slot described herein with reference to FIG. 5. The UE 115 may determine, based on the CCA level, whether a sub-channel is free or busy during the no SCI slot 815. For example, if the UE 115 determines that the sub-channel is busy during the slot 815, the UE 115 may determine that the LBT failure is due to one or more other RATs. Similarly, if the UE 115 determines that the sub-channel is free during the slot 815, the UE 115 may determine that the LBT failure may not be due to one or more other RATs.

As described with reference to FIG. 6, the LBT failure ratio (e.g., due to the other RAT(s)) may be used to determine (e.g., estimate) a competition level metric associated with the other RAT(s), which competition level metric may be used to determine a number of resources to reserve (e.g., a set of resource reservation approaches). As such, the UE 115 may reserve the resource(s) based on the competition level metric, which may be based on LBT failure due to other RAT(s).

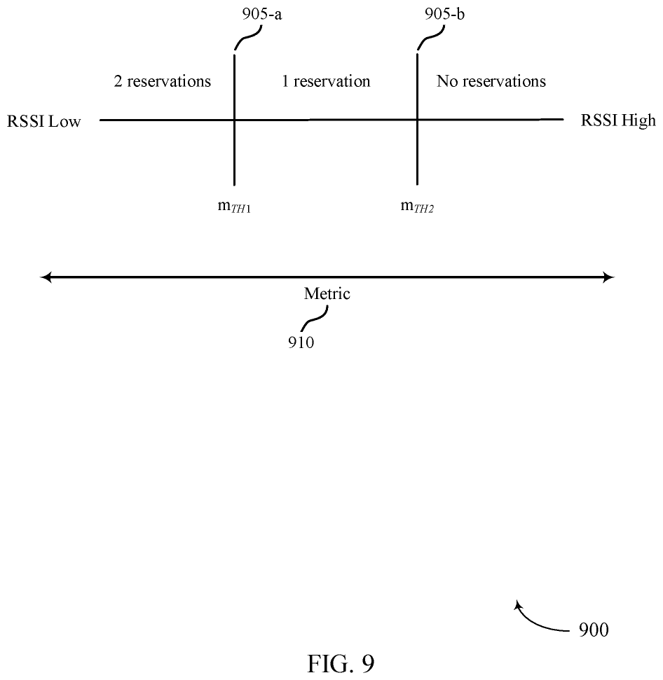

FIG. 9 illustrates an example of a mapping 900 that supports sidelink resource reservation in a shared band in accordance with one or more aspects of the present disclosure. Mapping 900 may be implemented by one or more UEs 115, which may represent one or more UEs 115 as described with reference to FIGS. 1-8. For example, as described with reference to FIG. 3, a UE 115 that operates on a sidelink band (e.g., sidelink unlicensed band) may perform an LBT-restricted reservation based on a value of a competition level metric 910 (e.g., to determine whether one or more other RATs are attempting to compete for resources in a same resource pool). The UE 115 may check the competition level metric 910 and the UE 115 may determine a set of resource reservation approaches, for example, using the mapping 900 and the competition level metric 910.

For example, the UE 115 may be configured with the mapping 900 to determine a set of resource reservation approaches (e.g., an allowed number of reservations) based on a determined value of the competition level metric 910 (e.g., the competition level metric 910 may map to a set of resource reservation approaches). For example, the UE 115 may identify (e.g., receive an indication of) the competition level metric 910 (e.g., receive a definition of the metric, such as an RSSI, a CCA failure ratio, or both) and an indication of one or more thresholds associated with the competition level metric 910, such as threshold 905-a (e.g., m_{TH1}) and a threshold 905-b (e.g., m_{TH2}). Based on the metric 910 and the one or more thresholds 905, the UE 115 may determine the set of resource reservation approaches (e.g., allowed number of reservations).

In one example, the measured competition level metric 910, m (e.g., in terms of RSSI), may be greater than the threshold 905-b (e.g., the measured RSSI may be high, m>m_{TH2}), and the UE 115 may not make any reservations (e.g., may be allowed no reservations) based on the mapping 900. In another example, the measured competition level metric 910, m, may be greater than the threshold 905-a and less than the threshold 905-b (e.g., the RSSI may be at a moderate level, m_{TH1}<m<m_{TH2}), and the UE 115 make one reservation (e.g., may be allowed one reservation) based on the mapping 900. In another example, the measured metric may be less than the threshold 905-a (e.g., the RSSI may be low, m<m_{TH1}), and the UE 115 may make two reservations (e.g., may be allowed two reservations) based on the mapping 900. Based on the mapping 900, the UE 115 may transmit SCI indicating the number of advanced reservations (e.g., allowed reservations) to inform other UEs 115 of the reservation(s).

In another example, the UE 115 may be allowed to reserve more than two resources (e.g., a COT reservation). In this case, the UE 115 may be configured with an additional, lower threshold (e.g., with respect to the competition level metric 910), where the UE 115 may refrain from transmitting a reservation of more than two resources if the competition level metric is greater than the additional threshold.

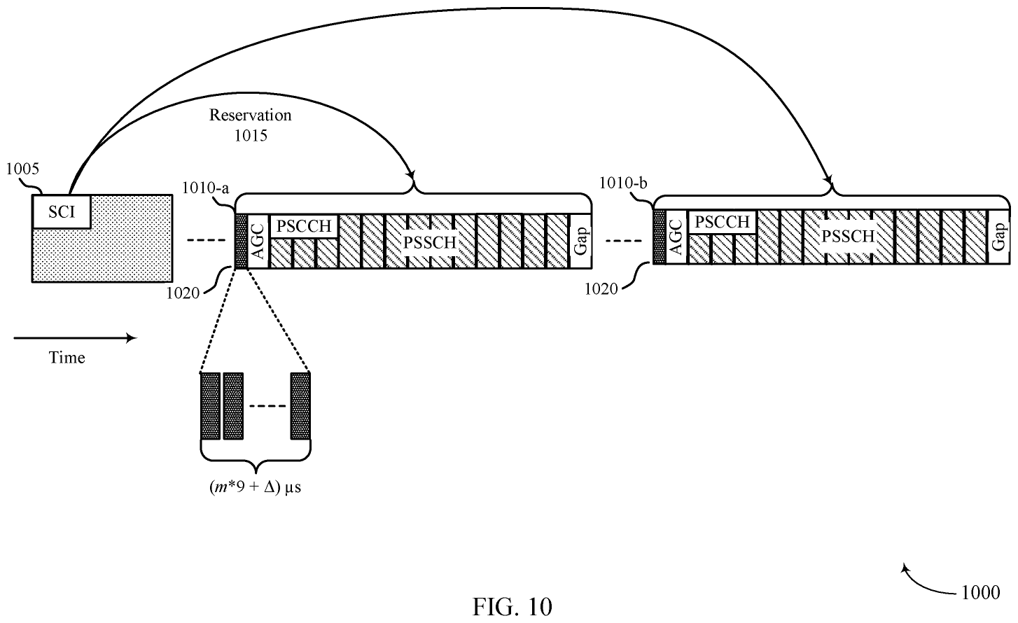

FIG. 10 illustrates an example of a resource selection scheme 1000 that supports sidelink resource reservation in a shared band in accordance with one or more aspects of the present disclosure. Resource selection scheme 1000 may be implemented by one or more UEs 115, which may be examples of one or more UEs 115 as described with reference to FIGS. 1-9. For example, as described with reference to FIG. 3, a UE 115 that operates on a sidelink band (e.g., sidelink unlicensed band) may perform an LBT-restricted reservation based on a value of a competition level metric (e.g., to determine whether one or more other RATs using resources in a same resource pool).

In some cases, in order to support continuous transmission at a sidelink slot (e.g., inter-slot continuous transmission), a sidelink UE 115 may perform CP extension (e.g., from an AGC symbol). For example, the UE 115 may transmit a resource reservation 1015 (e.g., via SCI 1005), indicating one or more future resources reserved for transmission, and indicating that the reserved resource(s) are associated with performing a CP extension 1020 (e.g., which may extend into previous symbols before a slot begins to secure channel access). In cases where the UE 115 supports performing CP extension, the resource pool may indicate (e.g., a configuration of the resource pool may indicate) a mapping from a competition level metric to a set of starting points 1010 for the CP extension 1020 (e.g., an allowed set of starting points).

For example, based on the competition level metric (e.g., a CCA failure rate, an RSSI, or both) the UE 115 may use one or more starting points 1010 (e.g., CP extension starting points 1010) for transmissions that use CP extension. The starting points 1010 may, for example, correspond to a length of a CP (e.g., used in CP extension), and may be based on the competition level metric. An earlier starting point 1010 may be associated with a shorter CP followed by a remainder of the transmission, and a later starting point may be associated with a longer CP followed by a remainder of the transmission. In some cases, a starting point 1010 may be determined by (m*9+Δ)μs, where m may represent a value of the competition level metric (e.g., an RSSI and/or LBT failure ratio, or one or more ranges thereof). In such cases, the UE 115 may determine a starting point 1010 for CP extension based on a range of values in which the competition level metric (e.g., m) is observed.

In one example, the UE 115 may use a starting point 1010-a for a first reserved resource associated with CP extension and a starting point 1010-b for a second reserved resource associated with CP extension, where the starting points 1010-a and 1010-b may correspond to the mapping from the competition level metric as described herein. For example, the UE 115 may reserve an earlier starting point 1010 (e.g., for CP extension) if the reservation 1015 by the UE 115 may be relatively reliable (e.g., having a lower competition level metric, such as a relatively low CCA failure rate) and may therefore have a shorter CP. Similarly, the UE 115 may reserve a later starting point (e.g., for CP extension) if the reservation 1015 by the UE 115 may be relatively less reliable (e.g., having a higher competition level metric, such as a relatively high CCA failure rate) and may therefore have a longer CP.

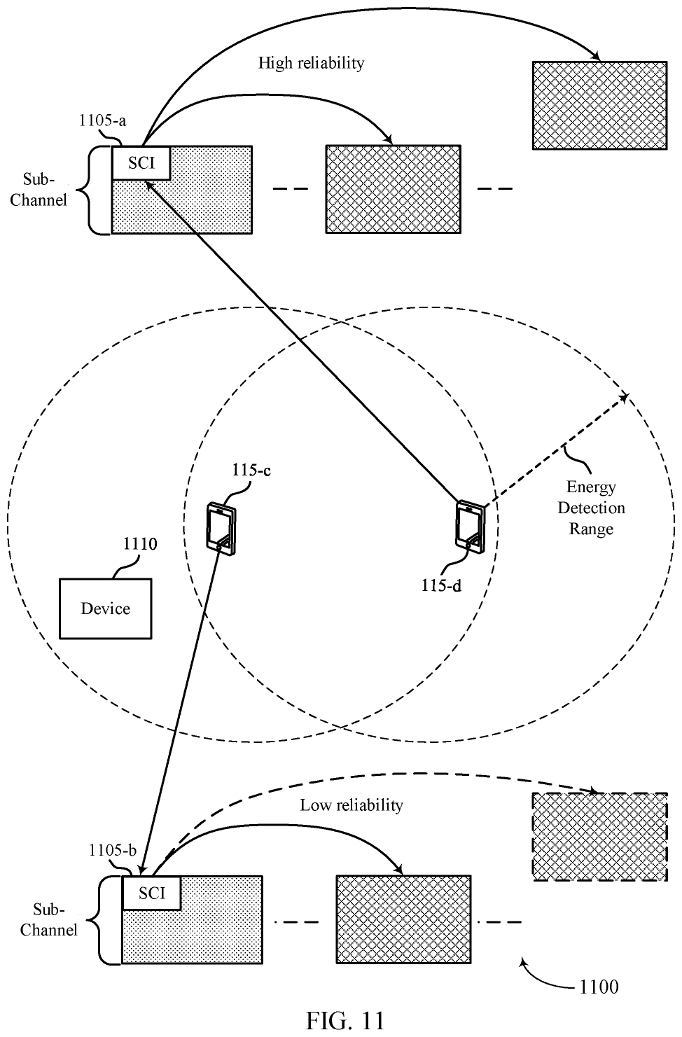

FIG. 11 illustrates an example of a wireless communications system 1100 that supports sidelink resource reservation in a shared band in accordance with one or more aspects of the present disclosure. Wireless communications system 1100 include by one or more UEs 115, which may be examples of one or more UEs 115 as described with reference to FIGS. 1-10. For example, as described with reference to FIGS. 3-10, a UE 115-c or a UE 115-d that operates on a sidelink band (e.g., a sidelink licensed band, a sidelink unlicensed band) may identify resources to use for a sidelink transmission based on a channel sensing procedure. Based on the resource identification, the UEs 115 may transmit SCI (e.g., SCI 1105-a, SCI 1105-b) to indicate an occupancy of a current sub-channel and reservation of one or more future sub-channels. In some examples (e.g., in SL-U), the UE 115-d may perform resource reservation according to LBT-based channel access, which may be impacted by one or more other competing RATs, such as a device 1110 using a different RAT (e.g., a Wi-Fi access point, a base station, a network device). For example, LBT procedures may make some resource reservations less reliable, such as if the UE 115-d may be blocked by the LBT procedure (e.g., by a failed LBT procedure, based on another competing RAT) and may be unable to transmit using one or more reserved resources.

In addition or as an alternative to the techniques described with reference to FIGS. 3-10, the resource pool (e.g., a configuration of the resource pool) may indicate for the UEs 115 to include an indication (e.g., a low bit indication) with respect to LBT uncertainty together with the resource reservation (e.g., in the respective SCI 1105). For example, UE 115-c and UE 115-d may each reserve (e.g., may be allowed to reserve) two resources per SCI 1105, where the resource reservations may each include respective reliability indications. The reliability indications may indicate (e.g., reflect) a quantized value of the measured competition level metric (e.g., RSSI, CCA failure ratio, or both), or may indicate whether the competition level metric observed by the UE is within a defined range. In some cases, the reliability indication may be included in (e.g., may be a part of) the set of resource reservation approaches mapped to the competition level metric.

In one example, the UE 115-c may transmit SCI 1105-b to reserve two resources, where the SCI 1105-b may include a low reliability indication based on a high (e.g., relatively high) measured competition level from device 1110 or one or more other RATs. The UE 115-d may transmit SCI 1105-a to reserve two resources, where the SCI 1105-a may include a high reliability indication based on a low (e.g., relatively low) measured competition level from device 1110 or other RATs.

In some cases, a UE 115 may be configured (e.g., based on a resource pool configuration) with a set of resource reservation approaches that includes a number of resources (e.g., among other resource parameters or restrictions as described herein) and a reliability indication. For example, when sending a reservation that is based on the competition level metric, a UE 115 may determine a number of permitted resource reservations and may additionally indicate a reservation reliability in the SCI 1105 carrying the resource reservation(s). For example, based on a relatively higher competition level metric measured by the UE 115-c, the UE 115-c may make one resource reservation (e.g., may be allowed to make one reservation) per SCI 1105, where the SCI 1105 may additionally carry a low reliability indication for the resource reservation.

The reliability indication may be utilized to perform reliability based (e.g., reliability-aware) sensing or re-evaluation. For example, if there are not enough available resources for a UE 115 (e.g., a sensing UE 115) to reserve, the UE 115 may relax RSRP threshold(s) for low reliability reservation(s) (e.g., may look at low-reliability reservations with a relaxed RSRP threshold(s)), for example, before relaxing an RSRP threshold for other reservations.

For example, the UE 115-d may not be able to reserve one or more resources due to unavailability of resources in the resource pool. The UE 115-d may monitor the reservations made by the UE 115-c, for example, including the reliability indication in the SCI 1105-b. The UE 115-d may determine that the reliability indication by the UE 115-c is relatively low (e.g., based on the competition level metric), and the UE 115-d may lower (e.g., relax) the RSRP threshold associated with the resources reserved by the UE 115-c.

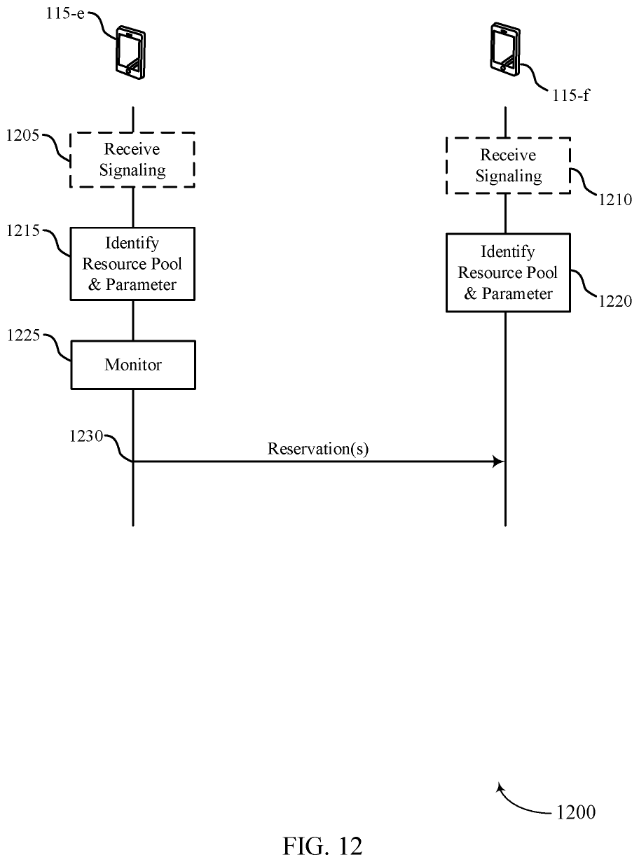

FIG. 12 illustrates an example of a process flow 1200 that supports sidelink resource reservation in a shared band in accordance with one or more aspects of the present disclosure. The process flow 1200 may implement or be implemented by aspects of the wireless communications system 100 or 300, as well as one or more aspects of mapping 900, wireless communications system 1100, or one or more of resource selection schemes 200, 400, 500, 600, 700, 800, or 1000, or any combination thereof. For example, process flow 1200 may be implemented by a UE 115-e and a UE 115-f, which may be examples of UEs 115 described with reference to FIGS. 1-11.

In the following description of process flow 1200, the operations may be performed in a different order than the order shown, or the operations performed by UE 115-e and UE 115-f may be performed in different orders or at different times. For example, some operations may also be left out of process flow 1200, or other operations may be added to process flow 1200. Although UE 115-e and UE 115-f are shown performing the operations of process flow 1200, some aspects of some operations may also be performed by one or more other wireless devices.

At 1205, in some cases, UE 115-e (e.g., using a first RAT, such as SL-U) may receive control signaling (e.g., from a network entity 105) indicating a sidelink resource pool of a shared band, and a parameter (e.g., a type, a measurement to perform) of a competition level metric. In some cases, at 1210, UE 115-f (e.g., using the first RAT) may additionally or alternatively receive control signaling (e.g., from a network entity 105) indicating the sidelink resource pool and the parameter (e.g., a type, a measurement to perform) of the competition level metric.

At 1215, UE 115-e may identify the sidelink resource pool of the shared resource band and the parameter of the competition level metric. As described herein with reference to FIGS. 3-11, the competition level metric may be for measuring communication activity in the shared resource band (e.g., unlicensed band), where the shared resource band may be associated with communication by the first RAT and a second RAT that differs from the first RAT. For example, in some cases, UE 115-e may identify the sidelink resource pool and the parameter of the competition level metric based on the signaling received at 1205. In some other cases, the UE 115-e may identify the sidelink resource pool and the parameter of the competition level metric based on one or more defined parameters or indications (e.g., stored at UE 115-e, defined by a wireless communications standard).

At 1220, UE 115-f may identify the sidelink resource pool of the shared resource band and the parameter of the competition level metric. For example, in some cases, UE 115-f may identify the sidelink resource pool and the parameter of the competition level metric based on the signaling received at 1210. In some other cases, the UE 115-f may identify the sidelink resource pool and the parameter of the competition level metric based on one or more defined parameters or indications (e.g., stored at UE 115-f, defined by a wireless communications standard).

At 1225, UE 115-e may monitor in accordance with the parameter of the competition level metric, at least one resource of the sidelink resource pool to determine the competition level metric for the shared resource band. For example, as described with reference to FIGS. 3-5, UE 115-e may determine a signal strength (e.g., RSSI) associated with the second RAT at one or more measurement periods associated with the sidelink resource pool, where the parameter of the competition level metric indicates that the competition level metric includes the signal strength. Additionally or alternatively, as described with reference to FIGS. 3 and 6-8, UE 115-e may determine a ratio of failed CCA procedures within the sidelink resource pool of the shared resource band over a time period, where the parameter of the competition level metric indicates that the competition level metric includes the ratio.

At 1230, UE 115-e may transmit one or more reservations for reserving one or more resources of the sidelink resource pool based on the competition level metric (e.g., may transmit one or more LBT-restricted reservations). In one example, as described with reference to FIG. 3, UE 115-e may select a number of reservations to send based on the competition level metric. For example, UE 115-e may map the competition level metric to the number of reservations, where the number of reservations is included in a set of multiple different numbers of resource reservations (e.g., each associated with one or more values of the competition level metric), as described with reference to FIGS. 3 and 9.

Additionally or alternatively, UE 115-e may transmit at least one of the one or more reservations that includes a reservation reliability indicator that is based on the competition level metric, as described with reference to FIG. 11. For example, UE 115-e may map the competition level metric to the reservation reliability indicator from a set of reservation reliability indicators, as described with reference to FIGS. 9 and 11. Additionally or alternatively, UE 115-e may map the competition level metric to a resource reservation restriction of a set of multiple resource reservation restrictions and may transmit the reservation(s) in accordance with the resource reservation restriction. The resource reservation restriction may, for example, be associated with one or more parameters of a COT or of a CP extension as described with reference to FIGS. 3 and 10.

Based on the LBT-restricted reservations, resource(s) reserved by UE 115-e may have a higher reliability, a higher probability of being used by UE 115-e, or both, which may increase communication reliability and quality.

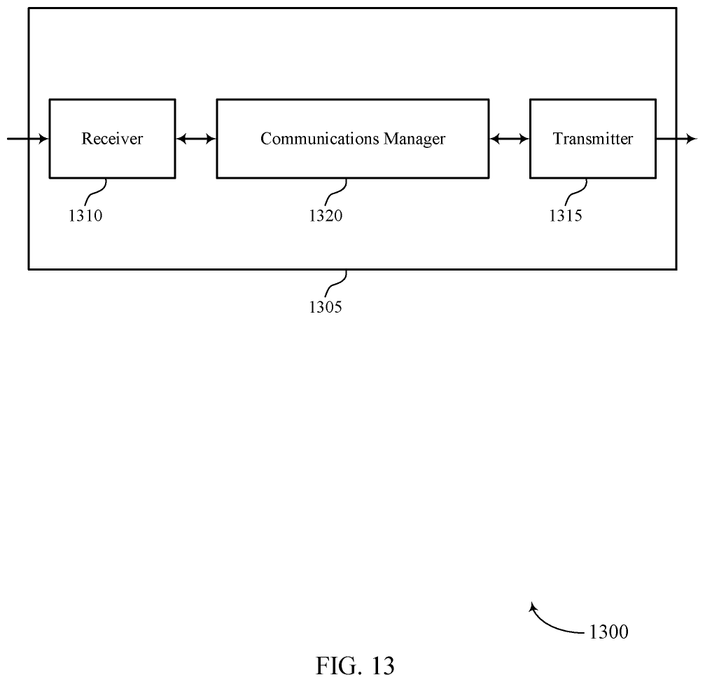

FIG. 13 shows a block diagram 1300 of a device 1305 that supports sidelink resource reservation in a shared band in accordance with one or more aspects of the present disclosure. The device 1305 may be an example of aspects of a UE 115 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to sidelink resource reservation in a shared band). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to sidelink resource reservation in a shared band). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of sidelink resource reservation in a shared band as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication of a UE operating using a first RAT in accordance with examples as disclosed herein. For example, the communications manager 1320 may be configured as or otherwise support a means for identifying a sidelink resource pool of a shared resource band and a parameter of a competition level metric for measuring communication activity in the shared resource band, the shared resource band associated with communication by the first RAT and a second RAT that differs from the first RAT. The communications manager 1320 may be configured as or otherwise support a means for monitoring, in accordance with the parameter of the competition level metric, at least one resource of the sidelink resource pool to determine the competition level metric for the shared resource band. The communications manager 1320 may be configured as or otherwise support a means for transmitting one or more reservations for reserving one or more resources of the sidelink resource pool based at least on part on the competition level metric.

Additionally, or alternatively, the communications manager 1320 may support wireless communication of a first UE operating using a first RAT in accordance with examples as disclosed herein. For example, the communications manager 1320 may be configured as or otherwise support a means for identifying a sidelink resource pool of a shared resource band and a parameter of a competition level metric for measuring communication activity in the shared resource band, the shared resource band associated with communication by the first RAT and a second RAT that differs from the first RAT. The communications manager 1320 may be configured as or otherwise support a means for receiving, from a second UE, an indication of one or more reservations for reserving one or more resources of the sidelink resource pool, the one or more reservations indicative of the competition level metric for the second UE in the shared resource band.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for increasing available battery power and communication quality at a wireless device (e.g., a UE 115) by supporting resource reservations with increased reliability based on a competition level metric, which may increase communication quality at the wireless device. The increase in communication quality may result in increased link performance and decreased overhead based on the increase in reservation reliability. Accordingly, communications manager 1320 may save power and increase battery life at a wireless device (e.g., a UE 115) by strategically increasing a quality of communications at a wireless device (e.g., a UE 115).

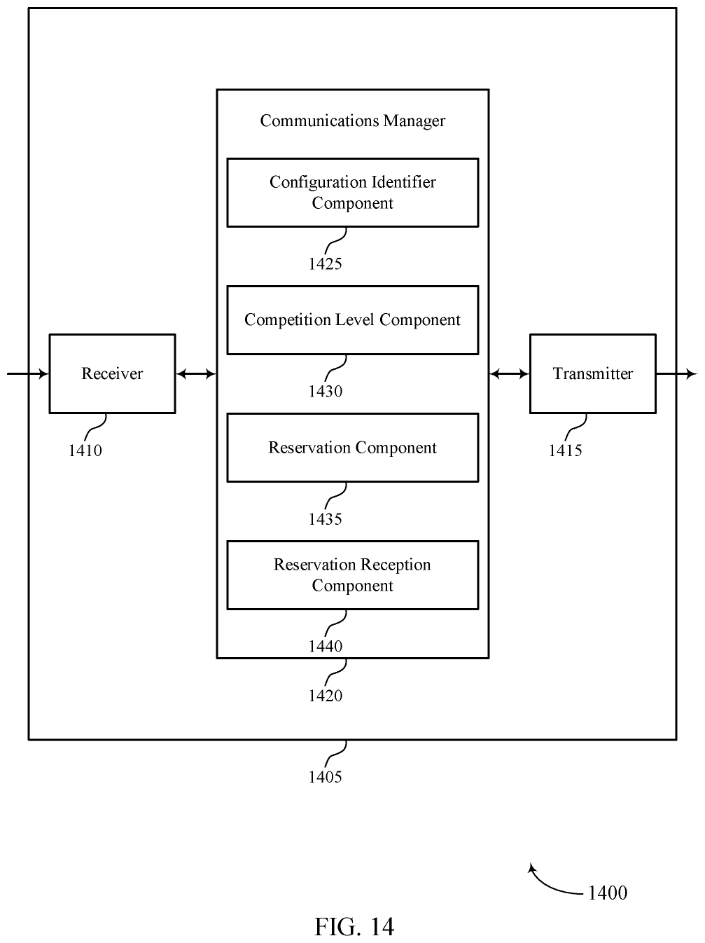

FIG. 14 shows a block diagram 1400 of a device 1405 that supports sidelink resource reservation in a shared band in accordance with one or more aspects of the present disclosure. The device 1405 may be an example of aspects of a device 1305 or a UE 115 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to sidelink resource reservation in a shared band). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to sidelink resource reservation in a shared band). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of sidelink resource reservation in a shared band as described herein. For example, the communications manager 1420 may include a configuration identifier component 1425, a competition level component 1430, a reservation component 1435, a reservation reception component 1440, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication of a UE operating using a first radio access technology in accordance with examples as disclosed herein. The configuration identifier component 1425 may be configured as or otherwise support a means for identifying a sidelink resource pool of a shared resource band and a parameter of a competition level metric for measuring communication activity in the shared resource band, the shared resource band associated with communication by the first radio access technology and a second radio access technology that differs from the first radio access technology. The competition level component 1430 may be configured as or otherwise support a means for monitoring, in accordance with the parameter of the competition level metric, at least one resource of the sidelink resource pool to determine the competition level metric for the shared resource band. The reservation component 1435 may be configured as or otherwise support a means for transmitting one or more reservations for reserving one or more resources of the sidelink resource pool based at least on part on the competition level metric.

Additionally, or alternatively, the communications manager 1420 may support wireless communication of a first UE operating using a first radio access technology in accordance with examples as disclosed herein. The configuration identifier component 1425 may be configured as or otherwise support a means for identifying a sidelink resource pool of a shared resource band and a parameter of a competition level metric for measuring communication activity in the shared resource band, the shared resource band associated with communication by the first radio access technology and a second radio access technology that differs from the first radio access technology. The reservation reception component 1440 may be configured as or otherwise support a means for receiving, from a second UE, an indication of one or more reservations for reserving one or more resources of the sidelink resource pool, the one or more reservations indicative of the competition level metric for the second UE in the shared resource band.

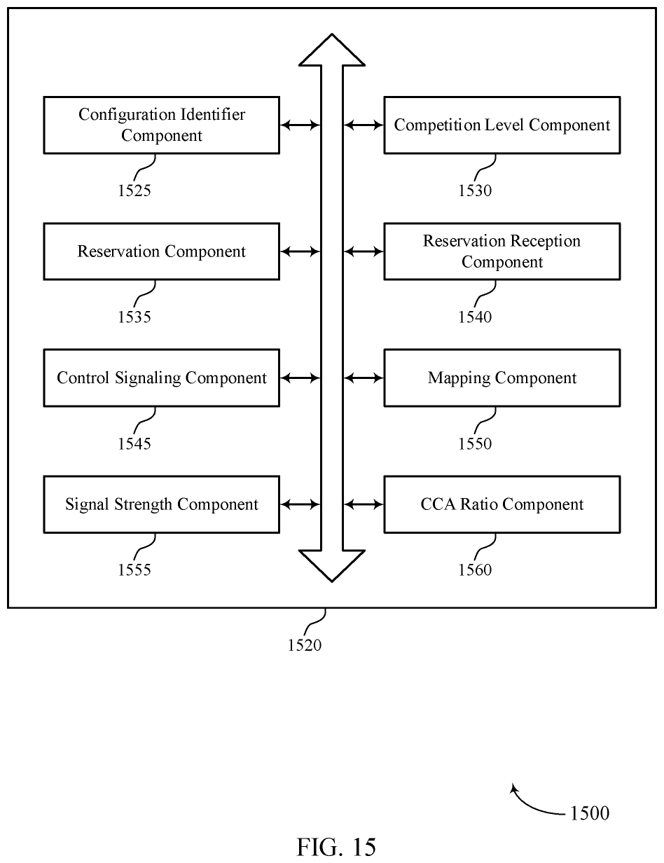

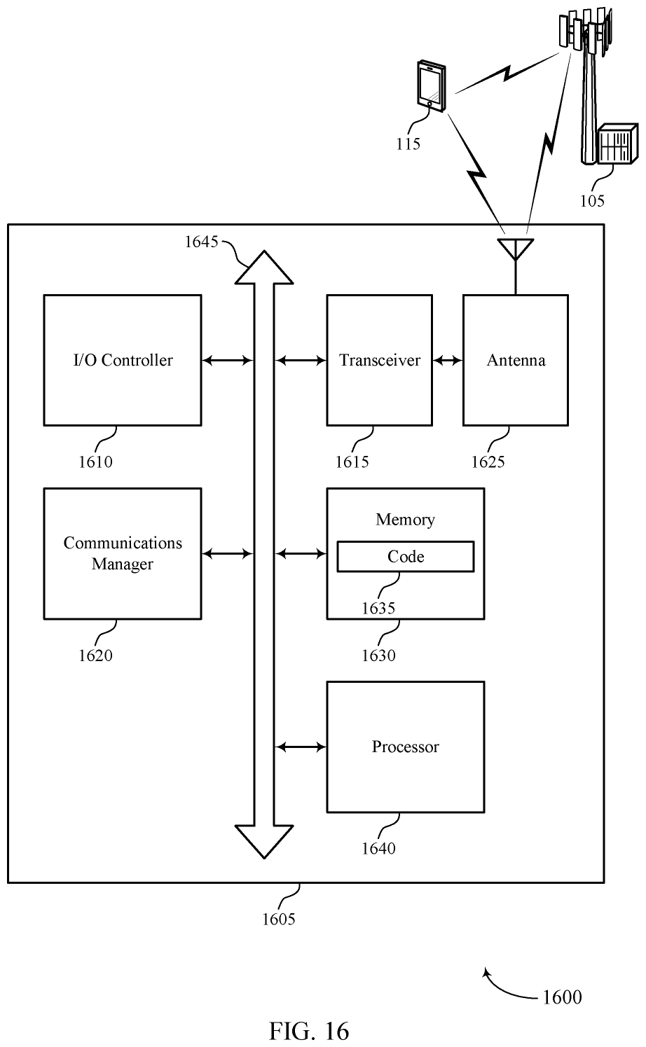

A processor of a wireless device (e.g., controlling the receiver 1410, the transmitter 1415, or the transceiver 1615 as described with reference to FIG. 16) may increase available battery power and communication quality. The increased communication quality may increase available battery power and throughput (e.g., via implementation of system components described with reference to FIG. 15) compared to other systems and techniques, for example, that do not support resource reservation based on competition levels from one or more other RATs. Further, the processor of the wireless device may identify one or more aspects of a competition level metric, which may result in increased communication quality, as well as save power and increase battery life at the wireless device (e.g., by strategically supporting increased resource reservation reliability), among other benefits.

FIG. 15 shows a block diagram 1500 of a communications manager 1520 that supports sidelink resource reservation in a shared band in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of sidelink resource reservation in a shared band as described herein. For example, the communications manager 1520 may include a configuration identifier component 1525, a competition level component 1530, a reservation component 1535, a reservation reception component 1540, a control signaling component 1545, a mapping component 1550, a signal strength component 1555, a CCA ratio component 1560, or any combination thereof. Each of these components may communicate, directly or indirectly, with one another (e.g., via one or more buses).

The communications manager 1520 may support wireless communication of a UE operating using a first RAT in accordance with examples as disclosed herein. The configuration identifier component 1525 may be configured as or otherwise support a means for identifying a sidelink resource pool of a shared resource band and a parameter of a competition level metric for measuring communication activity in the shared resource band, the shared resource band associated with communication by the first RAT and a second RAT that differs from the first RAT. The competition level component 1530 may be configured as or otherwise support a means for monitoring, in accordance with the parameter of the competition level metric, at least one resource of the sidelink resource pool to determine the competition level metric for the shared resource band. The reservation component 1535 may be configured as or otherwise support a means for transmitting one or more reservations for reserving one or more resources of the sidelink resource pool based at least on part on the competition level metric.

In some examples, to support identifying the sidelink resource pool and the parameter of the competition level metric, the control signaling component 1545 may be configured as or otherwise support a means for receiving control signaling that indicates the sidelink resource pool and the parameter of the competition level metric.

In some examples, the reservation component 1535 may be configured as or otherwise support a means for selecting a number of reservations to send based on the competition level metric, where transmitting the one or more reservations includes transmitting one or more reservations for reserving the one or more resources of the sidelink resource pool in accordance with the number of reservations.

In some examples, the mapping component 1550 may be configured as or otherwise support a means for mapping the competition level metric to the number of reservations from a set of multiple different numbers of resource reservations, where selecting the number of reservations is based at least in part the mapping.

In some examples, to support transmitting the one or more reservations, the reservation component 1535 may be configured as or otherwise support a means for transmitting at least one of the one or more reservations that includes a reservation reliability indicator that is based on the competition level metric.

In some examples, the mapping component 1550 may be configured as or otherwise support a means for mapping the competition level metric to the reservation reliability indicator from a set of reservation reliability indicators, where the reservation reliability indicator is based on the mapping.

In some examples, the reservation reliability indicator is associated with resource selection within the sidelink resource pool by one or more other UEs.

In some examples, the mapping component 1550 may be configured as or otherwise support a means for mapping the competition level metric to a resource reservation restriction of a set of multiple resource reservation restrictions, where transmitting the one or more reservations for reserving the one or more resources of the sidelink resource pool is based on the resource reservation restriction.

In some examples, the signal strength component 1555 may be configured as or otherwise support a means for determining a signal strength associated with the second RAT at one or more measurement periods associated with the sidelink resource pool, where the parameter of the competition level metric indicates that the competition level metric includes the signal strength.

In some examples, each of the one or more measurement periods includes a respective gap symbol of a respective sidelink slot, the respective gap symbol other than symbols used for sidelink transmissions by the first RAT.

In some examples, each of the one or more measurement periods includes a respective sidelink slot configured for measurement of the signal strength, the respective sidelink slot other than slots used for sidelink transmissions by the first RAT.

In some examples, the signal strength component 1555 may be configured as or otherwise support a means for determining a second signal strength associated with the second RAT over a first slot other than a slot in which sidelink control information is decoded.

In some examples, the CCA ratio component 1560 may be configured as or otherwise support a means for determining a ratio of failed CCA procedures within the sidelink resource pool of the shared resource band over a time period, where the parameter of the competition level metric indicates that the competition level metric includes the ratio.

In some examples, the ratio of failed CCA procedures is based on one or more CCA procedures other than CCA procedures performed for sidelink resources selected for communication by the UE.

In some examples, the ratio of failed CCA procedures is associated with CCA procedures performed for a CAPC corresponding to the sidelink resource pool.

In some examples, the CCA ratio component 1560 may be configured as or otherwise support a means for determining whether a CCA level associated with the second RAT satisfies a threshold at each of a set of measurement periods, where the ratio of failed CCA procedures is based on CCA procedures associated with one or more measurement periods of the set of measurement periods in which the threshold is satisfied.

In some examples, each of the set of measurement periods includes a respective gap symbol of a respective sidelink slot, the respective gap symbol other than symbols used for sidelink transmissions.

In some examples, each of the set of measurement periods includes a respective sidelink slot configured for measurement of the CCA level associated with the second RAT, the respective sidelink slot other than slots used for sidelink transmissions.

In some examples, the CCA ratio component 1560 may be configured as or otherwise support a means for determining whether a CCA level associated with the second RAT satisfies a threshold over a first slot other than a slot in which sidelink control information is decoded, where the ratio of failed CCA procedures is based on a CCA procedure associated with the first slot in which the threshold is satisfied.

Additionally, or alternatively, the communications manager 1520 may support wireless communication of a first UE operating using a first RAT in accordance with examples as disclosed herein. In some examples, the configuration identifier component 1525 may be configured as or otherwise support a means for identifying a sidelink resource pool of a shared resource band and a parameter of a competition level metric for measuring communication activity in the shared resource band, the shared resource band associated with communication by the first RAT and a second RAT that differs from the first RAT. The reservation reception component 1540 may be configured as or otherwise support a means for receiving, from a second UE, an indication of one or more reservations for reserving one or more resources of the sidelink resource pool, the one or more reservations indicative of the competition level metric for the second UE in the shared resource band.

In some examples, to support identifying the sidelink resource pool and the parameter of the competition level metric, the control signaling component 1545 may be configured as or otherwise support a means for receiving control signaling that indicates the sidelink resource pool and the parameter of the competition level metric.

In some examples, a number of the one or more reservations is associated with the competition level metric for the second UE.

In some examples, the number of the one or more reservations is based at least in part a mapping between the competition level metric and the number of the one or more reservations.

In some examples, to support receiving the one or more reservations, the reservation reception component 1540 may be configured as or otherwise support a means for receiving at least one of the one or more reservations that includes a reservation reliability indicator that is based on the competition level metric.

In some examples, the reservation reliability indicator is based at least in part a mapping between the competition level metric and the reservation reliability indicator.

In some examples, the reservation component 1535 may be configured as or otherwise support a means for selecting one or more second resources within the sidelink resource pool based on the reservation reliability indicator.

In some examples, the competition level metric is associated with a resource reservation restriction of a set of multiple resource reservation restrictions based on a mapping between the competition level metric and the resource reservation restriction.

In some examples, the parameter of the competition level metric indicates that the competition level metric includes a signal strength associated with the second RAT measured at one or more measurement periods associated with the sidelink resource pool.

In some examples, each of the one or more measurement periods includes a respective gap symbol of a respective sidelink slot, the respective gap symbol other than symbols used for sidelink transmissions by the first RAT.

In some examples, each of the one or more measurement periods includes a respective sidelink slot configured for measurement of the signal strength, the respective sidelink slot other than slots used for sidelink transmissions by the first RAT.

In some examples, the competition level metric is associated with determining a second signal strength associated with the second RAT over a first slot other than a slot in which sidelink control information is decoded.

In some examples, the parameter of the competition level metric indicates that the competition level metric includes a ratio of failed CCA procedures within the sidelink resource pool of the shared resource band over a time period.

In some examples, the ratio of failed CCA procedures is based on one or more CCA procedures other than CCA procedures performed for sidelink resources.

In some examples, the ratio of failed CCA procedures is associated with CCA procedures performed for a CAPC corresponding to the sidelink resource pool.

In some examples, the ratio of failed CCA procedures is based on CCA procedures associated with one or more measurement periods of a set of measurement periods in which threshold is satisfied by a CCA level associated with the second RAT.

In some examples, each of the set of measurement periods includes a respective gap symbol of a respective sidelink slot, the respective gap symbol other than symbols used for sidelink transmissions.

In some examples, each of the set of measurement periods includes a respective sidelink slot configured for measurement of the CCA level associated with the second RAT, the respective sidelink slot other than slots used for sidelink transmissions.

In some examples, the ratio of failed CCA procedures is based on a CCA procedure associated with a first slot other than a slot in which sidelink control information is decoded in which the threshold is satisfied by a CCA level associated with the second RAT.

FIG. 16 shows a diagram of a system 1600 including a device 1605 that supports sidelink resource reservation in a shared band in accordance with one or more aspects of the present disclosure. The device 1605 may be an example of or include the components of a device 1305, a device 1405, or a UE 115 as described herein. The device 1605 may communicate (e.g., wirelessly) with one or more network entities 105, one or more UEs 115, or any combination thereof. The device 1605 may include components for bi-directional voice and data communications including components for transmitting and receiving communications, such as a communications manager 1620, an input/output (I/O) controller 1610, a transceiver 1615, an antenna 1625, a memory 1630, code 1635, and a processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally or alternatively, the I/O controller 1610 may represent or interact with a modem, a keyboard, a mouse, a touchscreen, or a similar device. In some cases, the I/O controller 1610 may be implemented as part of a processor, such as the processor 1640. In some cases, a user may interact with the device 1605 via the I/O controller 1610 or via hardware components controlled by the I/O controller 1610.

In some cases, the device 1605 may include a single antenna 1625. However, in some other cases, the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include random access memory (RAM) and read-only memory (ROM). The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a basic I/O system (BIOS) which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting sidelink resource reservation in a shared band). For example, the device 1605 or a component of the device 1605 may include a processor 1640 and memory 1630 coupled with or to the processor 1640, the processor 1640 and memory 1630 configured to perform various functions described herein.

The communications manager 1620 may support wireless communication of a UE operating using a first RAT in accordance with examples as disclosed herein. For example, the communications manager 1620 may be configured as or otherwise support a means for identifying a sidelink resource pool of a shared resource band and a parameter of a competition level metric for measuring communication activity in the shared resource band, the shared resource band associated with communication by the first RAT and a second RAT that differs from the first RAT. The communications manager 1620 may be configured as or otherwise support a means for monitoring, in accordance with the parameter of the competition level metric, at least one resource of the sidelink resource pool to determine the competition level metric for the shared resource band. The communications manager 1620 may be configured as or otherwise support a means for transmitting one or more reservations for reserving one or more resources of the sidelink resource pool based at least on part on the competition level metric.

Additionally, or alternatively, the communications manager 1620 may support wireless communication of a first UE operating using a first RAT in accordance with examples as disclosed herein. For example, the communications manager 1620 may be configured as or otherwise support a means for identifying a sidelink resource pool of a shared resource band and a parameter of a competition level metric for measuring communication activity in the shared resource band, the shared resource band associated with communication by the first RAT and a second RAT that differs from the first RAT. The communications manager 1620 may be configured as or otherwise support a means for receiving, from a second UE, an indication of one or more reservations for reserving one or more resources of the sidelink resource pool, the one or more reservations indicative of the competition level metric for the second UE in the shared resource band.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of sidelink resource reservation in a shared band as described herein, or the processor 1640 and the memory 1630 may be otherwise configured to perform or support such operations.

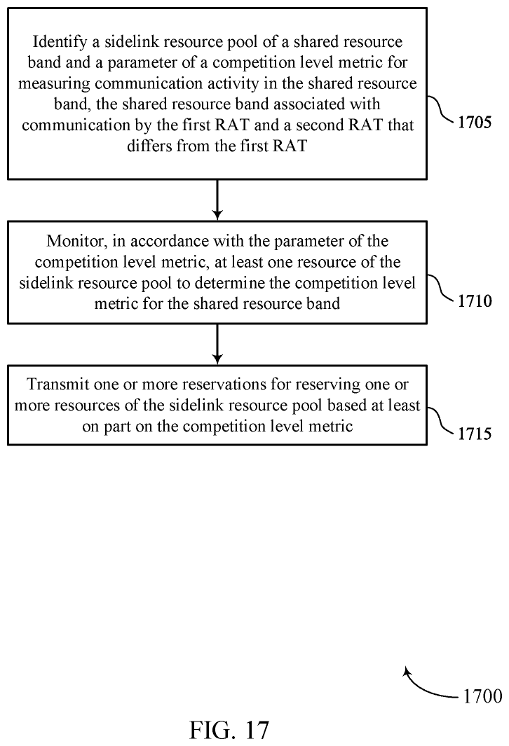

FIG. 17 shows a flowchart illustrating a method 1700 that supports sidelink resource reservation in a shared band in accordance with one or more aspects of the present disclosure. The operations of the method 1700 may be implemented by a UE or its components as described herein. For example, the operations of the method 1700 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 1705, the method may include identifying a sidelink resource pool of a shared resource band and a parameter of a competition level metric for measuring communication activity in the shared resource band, the shared resource band associated with communication by the first RAT and a second RAT that differs from the first RAT. The operations of 1705 may be performed in accordance with examples as disclosed herein. In some examples, aspects of the operations of 1705 may be performed by a configuration identifier component 1525 as described with reference to FIG. 15.

At 1710, the method may include monitoring, in accordance with the parameter of the competition level metric, at least one resource of the sidelink resource pool to determine the competition level metric for the shared resource band. The operations of 1710 may be performed in accordance with examples as disclosed herein. In some examples, aspects of the operations of 1710 may be performed by a competition level component 1530 as described with reference to FIG. 15.

At 1715, the method may include transmitting one or more reservations for reserving one or more resources of the sidelink resource pool based at least on part on the competition level metric. The operations of 1715 may be performed in accordance with examples as disclosed herein. In some examples, aspects of the operations of 1715 may be performed by a reservation component 1535 as described with reference to FIG. 15.

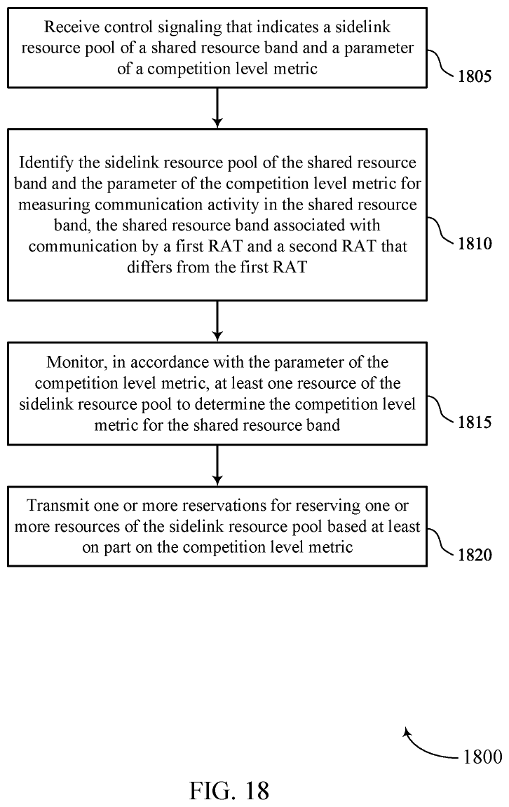

FIG. 18 shows a flowchart illustrating a method 1800 that supports sidelink resource reservation in a shared band in accordance with one or more aspects of the present disclosure. The operations of the method 1800 may be implemented by a UE or its components as described herein. For example, the operations of the method 1800 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 1805, the method may include receiving control signaling that indicates a sidelink resource pool of a shared resource band and a parameter of a competition level metric. The operations of 1805 may be performed in accordance with examples as disclosed herein. In some examples, aspects of the operations of 1805 may be performed by a control signaling component 1545 as described with reference to FIG. 15.

At 1810, the method may include identifying the sidelink resource pool of the shared resource band and the parameter of the competition level metric for measuring communication activity in the shared resource band, the shared resource band associated with communication by the first RAT and a second RAT that differs from the first RAT. The operations of 1810 may be performed in accordance with examples as disclosed herein. In some examples, aspects of the operations of 1810 may be performed by a configuration identifier component 1525 as described with reference to FIG. 15.

At 1815, the method may include monitoring, in accordance with the parameter of the competition level metric, at least one resource of the sidelink resource pool to determine the competition level metric for the shared resource band. The operations of 1815 may be performed in accordance with examples as disclosed herein. In some examples, aspects of the operations of 1815 may be performed by a competition level component 1530 as described with reference to FIG. 15.

At 1820, the method may include transmitting one or more reservations for reserving one or more resources of the sidelink resource pool based at least on part on the competition level metric. The operations of 1820 may be performed in accordance with examples as disclosed herein. In some examples, aspects of the operations of 1820 may be performed by a reservation component 1535 as described with reference to FIG. 15.

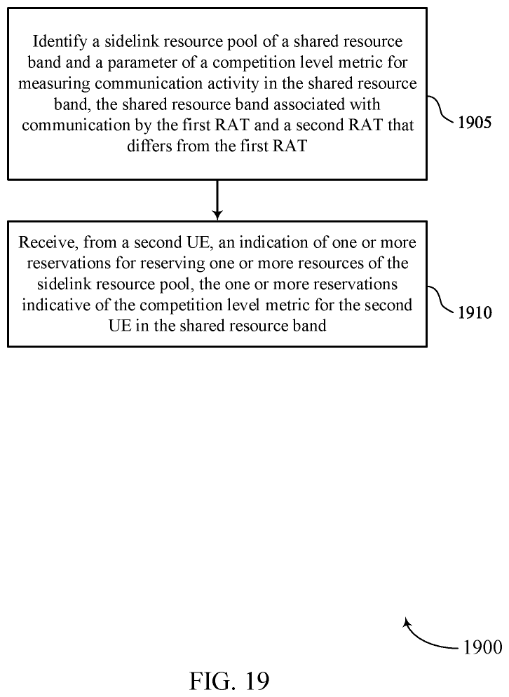

FIG. 19 shows a flowchart illustrating a method 1900 that supports sidelink resource reservation in a shared band in accordance with one or more aspects of the present disclosure. The operations of the method 1900 may be implemented by a UE or its components as described herein. For example, the operations of the method 1900 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 1905, the method may include identifying a sidelink resource pool of a shared resource band and a parameter of a competition level metric for measuring communication activity in the shared resource band, the shared resource band associated with communication by the first RAT and a second RAT that differs from the first RAT. The operations of 1905 may be performed in accordance with examples as disclosed herein. In some examples, aspects of the operations of 1905 may be performed by a configuration identifier component 1525 as described with reference to FIG. 15.

At 1910, the method may include receiving, from a second UE, an indication of one or more reservations for reserving one or more resources of the sidelink resource pool, the one or more reservations indicative of the competition level metric for the second UE in the shared resource band. The operations of 1910 may be performed in accordance with examples as disclosed herein. In some examples, aspects of the operations of 1910 may be performed by a reservation reception component 1540 as described with reference to FIG. 15.

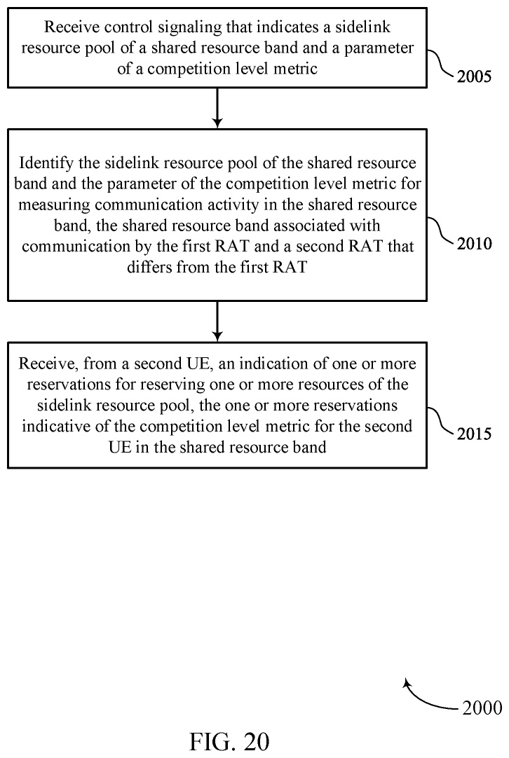

FIG. 20 shows a flowchart illustrating a method 2000 that supports sidelink resource reservation in a shared band in accordance with one or more aspects of the present disclosure. The operations of the method 2000 may be implemented by a UE or its components as described herein. For example, the operations of the method 2000 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2005, the method may include receiving control signaling that indicates a sidelink resource pool of a shared resource band and a parameter of a competition level metric. The operations of 2005 may be performed in accordance with examples as disclosed herein. In some examples, aspects of the operations of 2005 may be performed by a control signaling component 1545 as described with reference to FIG. 15.

At 2010, the method may include identifying the sidelink resource pool of the shared resource band and the parameter of the competition level metric for measuring communication activity in the shared resource band, the shared resource band associated with communication by the first RAT and a second RAT that differs from the first RAT. The operations of 2010 may be performed in accordance with examples as disclosed herein. In some examples, aspects of the operations of 2010 may be performed by a configuration identifier component 1525 as described with reference to FIG. 15.

At 2015, the method may include receiving, from a second UE, an indication of one or more reservations for reserving one or more resources of the sidelink resource pool, the one or more reservations indicative of the competition level metric for the second UE in the shared resource band. The operations of 2015 may be performed in accordance with examples as disclosed herein. In some examples, aspects of the operations of 2015 may be performed by a reservation reception component 1540 as described with reference to FIG. 15.

The following provides an overview of aspects of the present disclosure:

Aspect 1: A method for wireless communication of a UE operating using a first RAT, comprising: identifying a sidelink resource pool of a shared resource band and a parameter of a competition level metric for measuring communication activity in the shared resource band, the shared resource band associated with communication by the first RAT and a second RAT that differs from the first RAT; monitoring, in accordance with the parameter of the competition level metric, at least one resource of the sidelink resource pool to determine the competition level metric for the shared resource band; and transmitting one or more reservations for reserving one or more resources of the sidelink resource pool based at least on part on the competition level metric.

Aspect 2: The method of aspect 1, wherein identifying the sidelink resource pool and the parameter of the competition level metric further comprises: receiving control signaling that indicates the sidelink resource pool and the parameter of the competition level metric.

Aspect 3: The method of any of aspects 1 through 2, further comprising: selecting a number of reservations to send based at least in part on the competition level metric, wherein transmitting the one or more reservations comprises transmitting one or more reservations for reserving the one or more resources of the sidelink resource pool in accordance with the number of reservations.

Aspect 4: The method of aspect 3, further comprising: mapping the competition level metric to the number of reservations from a plurality of different numbers of resource reservations, wherein selecting the number of reservations is based at least in part the mapping.

Aspect 5: The method of any of aspects 1 through 4, wherein transmitting the one or more reservations comprises: transmitting at least one of the one or more reservations that comprises a reservation reliability indicator that is based at least in part on the competition level metric.

Aspect 6: The method of aspect 5, further comprising: mapping the competition level metric to the reservation reliability indicator from a set of reservation reliability indicators, wherein the reservation reliability indicator is based at least in part on the mapping.

Aspect 7: The method of any of aspects 5 through 6, wherein the reservation reliability indicator is associated with resource selection within the sidelink resource pool by one or more other UEs.

Aspect 8: The method of any of aspects 1 through 7, further comprising: mapping the competition level metric to a resource reservation restriction of a plurality of resource reservation restrictions, wherein transmitting the one or more reservations for reserving the one or more resources of the sidelink resource pool is based at least in part on the resource reservation restriction.

Aspect 9: The method of any of aspects 1 through 8, further comprising: determining a signal strength associated with the second RAT at one or more measurement periods associated with the sidelink resource pool, wherein the parameter of the competition level metric indicates that the competition level metric comprises the signal strength.

Aspect 10: The method of aspect 9, wherein each of the one or more measurement periods comprises a respective gap symbol of a respective sidelink slot, the respective gap symbol other than symbols used for sidelink transmissions by the first RAT.

Aspect 11: The method of aspect 9, wherein each of the one or more measurement periods comprises a respective sidelink slot configured for measurement of the signal strength, the respective sidelink slot other than slots used for sidelink transmissions by the first RAT.

Aspect 12: The method of any of aspects 9 through 11, further comprising: determining a second signal strength associated with the second RAT over a first slot other than a slot in which SCI is decoded.

Aspect 13: The method of any of aspects 1 through 12, further comprising: determining a ratio of failed CCA procedures within the sidelink resource pool of the shared resource band over a time period, wherein the parameter of the competition level metric indicates that the competition level metric comprises the ratio.

Aspect 14: The method of aspect 13, wherein the ratio of failed CCA procedures is based at least in part on one or more CCA procedures other than CCA procedures performed for sidelink resources selected for communication by the UE.

Aspect 15: The method of any of aspects 13 through 14, wherein the ratio of failed CCA procedures is associated with CCA procedures performed for a CAPC corresponding to the sidelink resource pool.

Aspect 16: The method of any of aspects 13 through 15, further comprising: determining whether a CCA level associated with the second RAT satisfies a threshold at each of a set of measurement periods, wherein the ratio of failed CCA procedures is based at least in part on CCA procedures associated with one or more measurement periods of the set of measurement periods in which the threshold is satisfied.

Aspect 17: The method of aspect 16, wherein each of the set of measurement periods comprises a respective gap symbol of a respective sidelink slot, the respective gap symbol other than symbols used for sidelink transmissions.

Aspect 18: The method of aspect 16, wherein each of the set of measurement periods comprises a respective sidelink slot configured for measurement of the CCA level associated with the second RAT, the respective sidelink slot other than slots used for sidelink transmissions.

Aspect 19: The method of any of aspects 16 through 18, further comprising: determining whether a CCA level associated with the second RAT satisfies a threshold over a first slot other than a slot in which SCI is decoded, wherein the ratio of failed CCA procedures is based at least in part on a CCA procedure associated with the first slot in which the threshold is satisfied.

Aspect 20: A method for wireless communication of a first UE operating using a first RAT, comprising: identifying a sidelink resource pool of a shared resource band and a parameter of a competition level metric for measuring communication activity in the shared resource band, the shared resource band associated with communication by the first RAT and a second RAT that differs from the first RAT; and receiving, from a second UE, an indication of one or more reservations for reserving one or more resources of the sidelink resource pool, the one or more reservations indicative of the competition level metric for the second UE in the shared resource band.

Aspect 21: The method of aspect 20, wherein identifying the sidelink resource pool and the parameter of the competition level metric further comprises: receiving control signaling that indicates the sidelink resource pool and the parameter of the competition level metric.

Aspect 22: The method of any of aspects 20 through 21, wherein a number of the one or more reservations is associated with the competition level metric for the second UE.

Aspect 23: The method of aspect 22, wherein the number of the one or more reservations is based at least in part a mapping between the competition level metric and the number of the one or more reservations.

Aspect 24: The method of any of aspects 20 through 23, wherein receiving the one or more reservations comprises: receiving at least one of the one or more reservations that comprises a reservation reliability indicator that is based at least in part on the competition level metric.

Aspect 25: The method of aspect 24, wherein the reservation reliability indicator is based at least in part a mapping between the competition level metric and the reservation reliability indicator.

Aspect 26: The method of any of aspects 24 through 25, further comprising: selecting one or more second resources within the sidelink resource pool based at least in part on the reservation reliability indicator.

Aspect 27: The method of any of aspects 20 through 26, wherein the competition level metric is associated with a resource reservation restriction of a plurality of resource reservation restrictions based at least in part on a mapping between the competition level metric and the resource reservation restriction.

Aspect 28: The method of any of aspects 20 through 27, wherein the parameter of the competition level metric indicates that the competition level metric comprises a signal strength associated with the second RAT measured at one or more measurement periods associated with the sidelink resource pool.

Aspect 29: The method of aspect 28, wherein each of the one or more measurement periods comprises a respective gap symbol of a respective sidelink slot, the respective gap symbol other than symbols used for sidelink transmissions by the first RAT.

Aspect 30: The method of aspect 28, wherein each of the one or more measurement periods comprises a respective sidelink slot configured for measurement of the signal strength, the respective sidelink slot other than slots used for sidelink transmissions by the first RAT.

Aspect 31: The method of any of aspects 28 through 30, wherein the competition level metric is associated with determining a second signal strength associated with the second RAT over a first slot other than a slot in which SCIis decoded.

Aspect 32: The method of any of aspects 20 through 31, wherein the parameter of the competition level metric indicates that the competition level metric comprises a ratio of failed CCA procedures within the sidelink resource pool of the shared resource band over a time period.

Aspect 33: The method of aspect 32, wherein the ratio of failed CCA procedures is based at least in part on one or more CCA procedures other than CCA procedures performed for sidelink resources.

Aspect 34: The method of any of aspects 32 through 33, wherein the ratio of failed CCA procedures is associated with CCA procedures performed for a CAPC corresponding to the sidelink resource pool.

Aspect 35: The method of any of aspects 32 through 34, wherein the ratio of failed CCA procedures is based at least in part on CCA procedures associated with one or more measurement periods of a set of measurement periods in which threshold is satisfied by a CCA level associated with the second RAT.

Aspect 36: The method of aspect 35, wherein each of the set of measurement periods comprises a respective gap symbol of a respective sidelink slot, the respective gap symbol other than symbols used for sidelink transmissions.

Aspect 37: The method of aspect 35, wherein each of the set of measurement periods comprises a respective sidelink slot configured for measurement of the CCA level associated with the second RAT, the respective sidelink slot other than slots used for sidelink transmissions.

Aspect 38: The method of any of aspects 35 through 37, wherein the ratio of failed CCA procedures is based at least in part on a CCA procedure associated with a first slot other than a slot in which SCI is decoded in which the threshold is satisfied by a CCA level associated with the second RAT.

Aspect 39: An apparatus for wireless communication of a UE operating using a first RAT, comprising a processor; memory coupled with the processor; and instructions stored in the memory and executable by the processor to cause the apparatus to perform a method of any of aspects 1 through 19.

Aspect 40: An apparatus for wireless communication of a UE operating using a first RAT, comprising at least one means for performing a method of any of aspects 1 through 19.

Aspect 41: A non-transitory computer-readable medium storing code for wireless communication of a UE operating using a first RAT, the code comprising instructions executable by a processor to perform a method of any of aspects 1 through 19.

Aspect 42: An apparatus for wireless communication of a first UE operating using a first RAT, comprising a processor; memory coupled with the processor; and instructions stored in the memory and executable by the processor to cause the apparatus to perform a method of any of aspects 20 through 38.

Aspect 43: An apparatus for wireless communication of a first UE operating using a first RAT, comprising at least one means for performing a method of any of aspects 20 through 38.

Aspect 44: A non-transitory computer-readable medium storing code for wireless communication of a first UE operating using a first RAT, the code comprising instructions executable by a processor to perform a method of any of aspects 20 through 38.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication of a user equipment (UE) operating using a first radio access technology, comprising:
identifying a sidelink resource pool of a shared resource band and a parameter of a competition level metric for measuring communication activity in the shared resource band, the shared resource band associated with communication by the first radio access technology and a second radio access technology that differs from the first radio access technology;
monitoring, in accordance with the parameter of the competition level metric, at least one resource of the sidelink resource pool to determine the competition level metric for the shared resource band; and
transmitting one or more reservations for reserving one or more resources of the sidelink resource pool based at least on part on the competition level metric.

2. The method of claim 1, wherein identifying the sidelink resource pool and the parameter of the competition level metric further comprises:
receiving control signaling that indicates the sidelink resource pool and the parameter of the competition level metric.

3. The method of claim 1, further comprising:
selecting a number of reservations to send based at least in part on the competition level metric, wherein transmitting the one or more reservations comprises transmitting one or more reservations for reserving the one or more resources of the sidelink resource pool in accordance with the number of reservations.

4. The method of claim 3, further comprising:
mapping the competition level metric to the number of reservations from a plurality of different numbers of resource reservations, wherein selecting the number of reservations is based at least in part the mapping.

5. The method of claim 1, wherein transmitting the one or more reservations comprises:
transmitting at least one of the one or more reservations that comprises a reservation reliability indicator that is based at least in part on the competition level metric.

6. The method of claim 5, further comprising:
mapping the competition level metric to the reservation reliability indicator from a set of reservation reliability indicators, wherein the reservation reliability indicator is based at least in part on the mapping.

7. The method of claim 5, wherein the reservation reliability indicator is associated with resource selection within the sidelink resource pool by one or more other UEs.

8. The method of claim 1, further comprising:
mapping the competition level metric to a resource reservation restriction of a plurality of resource reservation restrictions, wherein transmitting the one or more reservations for reserving the one or more resources of the sidelink resource pool is based at least in part on the resource reservation restriction.

9. The method of claim 1, further comprising:
determining a signal strength associated with the second radio access technology at one or more measurement periods associated with the sidelink resource pool, wherein the parameter of the competition level metric indicates that the competition level metric comprises the signal strength.

10. The method of claim 9, wherein each of the one or more measurement periods comprises a respective gap symbol of a respective sidelink slot, the respective gap symbol other than symbols used for sidelink transmissions by the first radio access technology.

11. The method of claim 9, wherein each of the one or more measurement periods comprises a respective sidelink slot configured for measurement of the signal strength, the respective sidelink slot other than slots used for sidelink transmissions by the first radio access technology.

12. The method of claim 9, further comprising:
determining a second signal strength associated with the second radio access technology over a first slot other than a slot in which sidelink control information is decoded.

13. The method of claim 1, further comprising:
determining a ratio of failed clear channel assessment procedures within the sidelink resource pool of the shared resource band over a time period, wherein the parameter of the competition level metric indicates that the competition level metric comprises the ratio.

14. The method of claim 13, wherein the ratio of failed clear channel assessment procedures is based at least in part on one or more clear channel assessment procedures other than clear channel assessment procedures performed for sidelink resources selected for communication by the UE.

15. The method of claim 13, wherein the ratio of failed clear channel assessment procedures is associated with clear channel assessment procedures performed for a channel access priority class corresponding to the sidelink resource pool.

16. The method of claim 13, further comprising:
determining whether a clear channel assessment level associated with the second radio access technology satisfies a threshold at each of a set of measurement periods, wherein the ratio of failed clear channel assessment procedures is based at least in part on clear channel assessment procedures associated with one or more measurement periods of the set of measurement periods in which the threshold is satisfied.

17. The method of claim 16, wherein each of the set of measurement periods comprises a respective gap symbol of a respective sidelink slot, the respective gap symbol other than symbols used for sidelink transmissions.

18. The method of claim 16, wherein each of the set of measurement periods comprises a respective sidelink slot configured for measurement of the clear channel assessment level associated with the second radio access technology, the respective sidelink slot other than slots used for sidelink transmissions.

19. The method of claim 16, further comprising:
determining whether a clear channel assessment level associated with the second radio access technology satisfies a threshold over a first slot other than a slot in which sidelink control information is decoded, wherein the ratio of failed clear channel assessment procedures is based at least in part on a clear channel assessment procedure associated with the first slot in which the threshold is satisfied.

20. A method for wireless communication of a first user equipment (UE) operating using a first radio access technology, comprising:
identifying a sidelink resource pool of a shared resource band and a parameter of a competition level metric for measuring communication activity in the shared resource band, the shared resource band associated with communication by the first radio access technology and a second radio access technology that differs from the first radio access technology; and
receiving, from a second UE, an indication of one or more reservations for reserving one or more resources of the sidelink resource pool, the one or more reservations indicative of the competition level metric for the second UE in the shared resource band.

21. The method of claim 20, wherein identifying the sidelink resource pool and the parameter of the competition level metric further comprises:
receiving control signaling that indicates the sidelink resource pool and the parameter of the competition level metric.

22. The method of claim 20, wherein a number of the one or more reservations is associated with the competition level metric for the second UE.

23. The method of claim 22, wherein the number of the one or more reservations is based at least in part a mapping between the competition level metric and the number of the one or more reservations.

24. The method of claim 20, wherein receiving the one or more reservations comprises:
receiving at least one of the one or more reservations that comprises a reservation reliability indicator that is based at least in part on the competition level metric.

25. The method of claim 24, wherein the reservation reliability indicator is based at least in part a mapping between the competition level metric and the reservation reliability indicator.

26. The method of claim 24, further comprising:
selecting one or more second resources within the sidelink resource pool based at least in part on the reservation reliability indicator.

27. The method of claim 20, wherein the parameter of the competition level metric indicates that the competition level metric comprises a signal strength associated with the second radio access technology measured at one or more measurement periods associated with the sidelink resource pool.

28. The method of claim 20, wherein the parameter of the competition level metric indicates that the competition level metric comprises a ratio of failed clear channel assessment procedures within the sidelink resource pool of the shared resource band over a time period.

29. An apparatus for wireless communication of a user equipment (UE) operating using a first radio access technology, comprising:
a processor;
memory coupled with the processor; and
instructions stored in the memory and executable by the processor to cause the apparatus to:
identify a sidelink resource pool of a shared resource band and a parameter of a competition level metric for measuring communication activity in the shared resource band, the shared resource band associated with communication by the first radio access technology and a second radio access technology that differs from the first radio access technology;
monitor, in accordance with the parameter of the competition level metric, at least one resource of the sidelink resource pool to determine the competition level metric for the shared resource band; and
transmit one or more reservations for reserving one or more resources of the sidelink resource pool based at least on part on the competition level metric.

30. An apparatus for wireless communication of a first user equipment (UE) operating using a first radio access technology, comprising:
a processor;
memory coupled with the processor; and
instructions stored in the memory and executable by the processor to cause the apparatus to:
identify a sidelink resource pool of a shared resource band and a parameter of a competition level metric for measuring communication activity in the shared resource band, the shared resource band associated with communication by the first radio access technology and a second radio access technology that differs from the first radio access technology; and
receive, from a second UE, an indication of one or more reservations for reserving one or more resources of the sidelink resource pool, the one or more reservations indicative of the competition level metric for the second UE in the shared resource band.
